(19) United States
(12) Patent Application Publication
(10) Pub. No.: US 2004/0126004 A1
(43) Pub. Date: Jul. 1, 2004

(54) Evaluation method, position detection method, exposure method and device manufacturing method, and exposure apparatus

(75) Inventor: Takahisa Kikuchi, Saitama-City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Chiyoda-ku (JP)

(21) Appl. No.: 10/735,840

(22) Filed: Dec. 16, 2003

Related U.S. Application Data
(63) Continuation of application No. 09/867,464, filed on May 31, 2001, now abandoned.

(30) Foreign Application Priority Data
May 31, 2000 (JP) 2000-161323
May 28, 2001 (JP) 2001-159388

(51) Int. Cl. G06K 9/00

(52) U.S. Cl. 382/141

(57) ABSTRACT

For a wafer earlier than a n'th wafer (n≧2) in a lot, a method (and an apparatus) of this invention detects positions of all shot areas, separates a nonlinear component and linear component of each of position deviation amounts, evaluates nonlinear distortion of the wafer based on the position deviation amounts and an evaluation function, and calculates nonlinear components of the position deviation amounts of all shot areas according to a complement function determined based on the evaluation results. On the other hand, for the n'th or later wafer, the method (and the apparatus) calculates position coordinates, of all shot areas, having linear components of position deviation amounts thereof corrected by using EGA, and detects positions of the shot areas based on the position coordinates having linear components thereof corrected and the nonlinear components calculated in the above.

### BACKGROUND OF THE INVENTION

1. Field of the Invention

The present invention relates to an evaluation method, a position detection method, an exposure method and a device manufacturing method, and an exposure apparatus, and more specifically to an evaluation method for evaluating regularity and degree of a nonlinear distortion of part of a substrate, a position detection method for detecting positions of a plurality of divided areas arranged on the substrate using the evaluation method, an exposure method using the position detection method and a device manufacturing method using the exposure method, and an exposure apparatus using the position detection method.

2. Description of the Related Art

Recently, in a manufacturing process of devices such as semiconductor devices an exposure apparatus of the step-and-repeat method or the step-and-scan method, and a wafer prober or a laser repair unit have been used. These units need to highly accurately align each of a plurality of chip pattern areas (shot areas) arranged in a matrix-shape on a substrate with respect to a predetermined reference point (e.g. process point of a unit) in a stationary coordinate system (i.e. an orthogonal coordinate system defined by a laser interferometer) defining position of the substrate.

Especially, an exposure apparatus needs to keep the accuracy of alignment high and stable so as to prevent the drop of yield due to occurrence of defective products when aligning a wafer with respect to a projection point of a pattern formed on a mask or reticle (to be generically referred to as a “reticle” hereinafter).

Usually, in an exposure process, a circuit pattern is formed by transferring ten or more layers onto a wafer aligning the layers with each other. If the accuracy of alignment between the layers is low, the characteristics of the circuit may be badly affected. In such a case, the chips may have characteristics thereof degraded, and in the worst case, become defective products causing the drop of the yield. Therefore, for the exposure process an alignment mark is provided on each of a plurality of shot areas on the wafer, and the position (coordinate value) of the alignment mark is detected. After that, based on the mark position information and known position information of the reticle pattern measured beforehand the shot area is aligned with respect to the reticle pattern (wafer alignment).

As such a wafer alignment, there are two main methods. One method is a die-by-die (D/D) alignment method that detects the alignment mark of each shot area on a wafer and performs alignment. The other is a global-alignment method that aligns each shot area by detecting an alignment mark of some of shot areas on a wafer and obtaining regularity of shot areas' arrangement. At present, device manufacturing lines use a global-alignment method, given the better throughput. Especially, an enhanced-global-alignment (EGA) is mainly used that accurately detects regularity of shot areas' arrangement on a wafer by using a statistic method as disclosed in, for example, in Japanese Patent Laid-Open No. 61-44429 and U.S. Pat. No. 4,780,617 corresponding thereto, and Japanese Patent Laid-Open No. 62-84516.

The EGA method measures position coordinates of a plurality of shot areas (more than or equal to three, usually 7 through 15 shot areas) selected as specific shot areas on a wafer, calculates position coordinates (arrangement of shot areas) of all shot areas on the wafer by using a statistic computation (least square method, etc.), and moves a wafer stage according to the calculated arrangement of the shot areas by stepping. This method has an advantage of shorter measurement time, and an averaging effect due to random measurement errors can be expected.

In the below, the statistic computation of the EGA method will be briefly described. It is assumed that a linear model given by the following equation (1) represents deviations (ΔXₙ, ΔYₙ) relative to respective arrangement coordinates on design, having (Xₙ, Yₙ) (n=1, 2, through m) symbolize the arrangement coordinates, on design, of m specific shot areas on a wafer (m is an integer, and m≧3), the specific shot areas being referred to as “sample shot areas” or “alignment shot areas”.

$$( \begin{matrix}Δ {X}_{n} \\ Δ {Y}_{n}\end{matrix} ) = ( \begin{matrix}a & b \\ c & d\end{matrix} ) ( \begin{matrix} {X}_{n} \\ {Y}_{n}\end{matrix} ) + ( \begin{matrix}e \\ f\end{matrix} ) \qquad ( 1 )$$

Furthermore, having (Δxₙ, Δyₙ) symbolize deviations, of actually-measured arrangement coordinates of the m sample shot areas, relative to the respective arrangement coordinates on design, the sum E of values each of which is the square of the difference between different one of these deviations and respective one of the deviations represented by the above linear model given by the following equation (1) is given by the following equation (2).

E=Σ{(Δxₙ−ΔXₙ)²+(Δyₙ−ΔYₙ)²} (2)

By finding values of parameters a, b, c, d, e, f to make the value of the equation (2) smallest, the parameter values are determined. Based on the parameters a through f and the arrangement coordinates on design, the EGA method calculates the arrangement coordinates of all shot areas on the wafer.

In the same device manufacturing line, overlay exposure is often performed using different exposure apparatuses for layers of a circuit pattern. In such a case, because there are grid errors between respective stages of the exposure apparatuses, overlay errors occur, the grid errors being errors between stage coordinate systems which each define position of a wafer in a respective exposure apparatus. Moreover, even in a case where there is no grid error between the respective stages of the exposure apparatuses, or where the same exposure apparatus is used for all layers, overlay errors may occur because of distortion of the arrangement of shot areas caused by processes such as etching, CVD and CMP between exposure processes of the layers.

In this case, if a fluctuation of arrangement errors between shot areas that causes the overlay error (arrangement error between shot areas) has only a linear component, the wafer alignment of the EGA method can remove the effect of the fluctuation. However, if the fluctuation has a nonlinear component, it is difficult to remove the effect. That is because, as seen in the above explanation, the EGA method assumes that the arrangement errors between shot areas on a wafer are linear, or in other words that the EGA computation uses a first order approximation. Accordingly, the EGA method can correct only a linear component due to wafer expansion and contraction or rotation, and it is difficult to correct local fluctuations of arrangement errors on a wafer, i.e. nonlinear distortion, by using the EGA method.

At present, to try to deal with the nonlinear distortion, a wafer alignment of a so-called weighted EGA method is used that is disclosed in, for example, in Japanese Patent Laid-Open No. 5-304077 and U.S. Pat. No. 5,525,808 corresponding thereto. The weighted EGA method will be briefly described in the below.

That is, in the weighted EGA method, position coordinates, in a stationary coordinate system, of three sample shot areas that are selected beforehand out of a plurality of shot areas on a wafer are measured, and so as to determine the position coordinate of each shot area, the position coordinates, in a stationary coordinate system, of the sample shot areas are weighted according to respective distances between the center of the shot area and the centers of the sample shot areas, or according to the distance (first information) between the shot area and a given point on the wafer, and the distances (second information) between the given point and sample shot areas. Then by performing a statistic computation (the least square method or simple averaging) using the weighted position coordinates, the position coordinate of the shot area is determined. Based on the position coordinates of the plurality of shot areas on the wafer, each shot area is aligned with respect to a predetermined reference position (e.g. transfer position of a reticle pattern) in a stationary coordinate system.

According to the weighted EGA method, even for a wafer having local arrangement errors (nonlinear distortion), it is possible to highly accurately align each shot area with respect to a predetermined reference position at high speed, with holding down the number of sample shots and the calculation amount.

Moreover, as disclosed in the above Japanese Patent Laid-Open, by using, for example, weights Wᵢₙ given by the equation (4), the weighted EGA method calculates, for each shot area, the parameters a, b, c, d, e, f to make the sum of squares Eᵢ given by the equation (3) smallest, each of the squares being the square of a residual difference.

$$\begin{matrix}{E}_{i} = {\sum }_{n = 1}^{m} {W}_{i n} \{ {( Δ {x}_{n} - Δ {X}_{n} )}^{2} + {( Δ {y}_{n} - Δ {Y}_{n} )}^{2} \} & ( 3 ) \\ {W}_{i n} = \frac{1}{\sqrt{2 π S}} {ⅇ}^{- {L}_{kn}^{2} / 2 S} & ( 4 )\end{matrix}$$

In the above equation (4), Lₖₙ represents the distance between a given shot area (an i'th shot area) and an n'th sample shot, and S represents a parameter concerning the weights.

Or by using weights Wᵢₙ′ given by the equation (6), the weighted EGA method calculates, for each shot area, the parameters a, b, c, d, e, f to make the sum of squares Eᵢ′ given by the equation (5) smallest, each of the squares being the square of a residual difference.

$$\begin{matrix}{E}_{i}^{′} = {\sum }_{n = 1}^{m} {W}_{i n}^{′} \{ {( Δ {x}_{n} - Δ {X}_{n} )}^{2} + {( Δ {y}_{n} - Δ {Y}_{n} )}^{2} \} & ( 5 ) \\ {W}_{i n}^{′} = \frac{1}{\sqrt{2 π S}} {ⅇ}^{- {( {L}_{Ei} - {L}_{Wn} )}^{2} / 2 S} & ( 6 )\end{matrix}$$

In the above equation (6), L_{Ei} represents the distance between a given shot area (the i'th shot area) and a given point (wafer center), and L_{Wn} represents the distance between the n'th sample shot and the given point (wafer center). The parameter S of the equations (4), (6) is given by, for example, the following equation (7).

$$S = \frac{{B}^{2}}{8 \cdot {Log}_{e} 10} \qquad ( 7 )$$

In the equation (7), B represents a weight parameter, and the physical meaning thereof is a range of sample shots valid to calculate the position coordinate of each shot area on a wafer (hereinafter, simply referred to as a “zone”). Accordingly, because, if the zone is large, the number of sample shots used for the calculation is large, the calculation result becomes close to that of the usual EGA method. On the other hand, because, if the zone is small, the number of sample shots used for the calculation is small, the calculation result becomes close to that of the D/D method.

Although an exposure apparatus of the present is capable of selecting one from five levels of the above parameter (the maximum is the size of the wafer), the selection of a level depends on the experience of the operator or experiment results of actually performing alignment exposure, or a method of using simulation to determine a suitable range is employed. That is, because the grounds based on which the weight parameter (zone) is selected is not clear, there has been no other way than to depend on a rule of thumb.

Furthermore, in the weighted EGA method, in the case of processing consecutively a large number of wafers, even if the wafers have been through the same process, measurement of alignment marks needs to be performed on at least selected sample shots of all wafers. Especially, although almost all EGA measurement points need to be measured to obtain the alignment measurement accuracy of the same level as the D/D method, that will cause the drop of the throughput.

Moreover, in the weighted EGA method according to the prior art, the number of EGA measurement points is determined depending on a rule of thumb.

### SUMMARY OF THE INVENTION

The present invention is invented under such a circumstance, and a first purpose is to provide an evaluation method for appropriately evaluating the nonlinear distortions of wafers not depending on a rule of thumb.

a second purpose of the present invention is to provide a position detection method for detecting position information used to highly accurately align each of a plurality of divided areas on a wafer with respect to a predetermined point at high speed, not depending on a rule of thumb.

a third purpose of the present invention is to provide an exposure method that can improve the accuracy of exposure upon exposure process of a plurality of substrates.

a fourth purpose of the present invention is to provide a device manufacturing method that can improve the productivity of micro devices.

a fifth purpose of the present invention is to provide an exposure apparatus that can realize highly accurate exposure with a high throughput and with accurately correcting both an overlay error fluctuating between lots and an overlay error fluctuating between processes.

According to a first aspect of the present invention, there is provided an evaluation method that evaluates regularity and degree of a nonlinear distortion of a substrate, comprising: the step of obtaining, for a plurality of divided areas on a substrate, position deviation amounts relative to predetermined reference positions by detecting respective marks, which are provided corresponding to said plurality of divided areas; and the step of evaluating regularity and degree of a nonlinear distortion of said substrate by using an evaluation function that is used to obtain correlation, concerning at least direction, between a first vector representing said position deviation amount of a given divided area on said substrate and second vectors each of which represents said position deviation amount of a divided area of a plurality of divide areas around said given divided area.

According to this, for a plurality of divided areas on a substrate, position deviation amounts relative to predetermined reference positions are obtained by detecting respective marks, which are provided corresponding to the plurality of divided areas, and regularity and degree of a nonlinear distortion of the substrate are evaluated by using an evaluation function that is used to obtain correlation, concerning at least direction, between a first vector representing the position deviation amount of a given divided area on the substrate and second vectors each of which represents the position deviation amount of a divided area of a plurality of divide areas around the given divided area. The higher correlation (close to one) obtained by this evaluation function means that the directions of nonlinear distortions of a given divided area and divided areas around it are closer to one another, and The lower correlation (close to zero) means that the directions of nonlinear distortions of a given divided area and divided areas around it are random. In addition, consider that there is a so-called jump area among a plurality of divided areas, of which the measurement error is larger than the other areas. Because the jump area has almost no correlation with areas around it, by using the above evaluation function the effect of such a jump area can be reduced.

Accordingly, the nonlinear distortion of a substrate can be appropriately evaluated not depending on a rule of thumb. In addition, based on the evaluation results, for example, at least one of the number and arrangement of measurement points (marks) for measuring position information in the EGA method or weighted EGA method can be appropriately determined not depending on a rule of thumb. Incidentally, marks used to measure position information are usually provided corresponding to a plurality of specific shot areas (sample shots), selected beforehand, on the substrate.

In this case, the evaluation function may be a function to obtain correlation, in direction and size, between the first vector and the second vectors.

The evaluation method according to this invention can further comprise the step of, by using the evaluation function, determining a correction value of position information to align each of the divided areas with respect to a predetermined point.

In the evaluation method according to this invention, said evaluation function may be a second function that represents an average of first N functions each of which is used to obtain correlation, concerning at least direction, between said first vector obtained by selecting a respective divided area of N divided areas on said substrate and said second vectors each of which represents said position deviation amount of a divided area of a plurality of divide areas around said respective divided area of said N divided areas, N being a natural number. According to the evaluation function, the regularity and degree of a nonlinear distortion of areas, on the substrate, including the N divided areas can be evaluated not depending on a rule of thumb. Especially, when N is the total number of areas on the substrate, the regularity and degree of a nonlinear distortion of the entire substrate can be evaluated not depending on a rule of thumb.

According to a second aspect of the present invention, there is provided a first position detection method that detects pieces of position information to be used to align each of a plurality of divided areas on a substrate with respect to a predetermined point, said method comprising: calculating said piece of position information through use of a statistic computation using measured position information obtained by detecting said plurality of marks on said substrate; and determining, for said piece of position information, at least one of a correction value and a correction parameter that determines said correction value, by using a function that is used to obtain correlation, concerning at least direction, between a first vector representing a position deviation amount of a given divided area on said substrate and second vectors each of which represents a position deviation amount of a divided area of a plurality of divide areas around said given divided area, said position deviation amount of said first vector being relative to a predetermined reference position, said position deviation amounts of said second vectors being relative to respective predetermined reference positions.

In the description of this invention, a piece of “position information” of each divided area contains entire information concerning position thereof, appropriate for a statistic computation, such as a position deviation amount of the divided area relative to a respective design value, a relative position of the divided area to a predetermined reference position (e.g. position of the divided area relative to a mask on an exposure apparatus), and the distances between centers of the divided areas.

According to this, the piece of position information is calculated through use of a statistic computation using measured position information obtained by detecting the plurality of marks on the substrate, and for the piece of position information, at least one of a correction value and a correction parameter that determines the correction value is determined by using a function that is used to obtain correlation, concerning at least direction, between a first vector representing a position deviation amount of a given divided area on the substrate and second vectors each of which represents a position deviation amount of a divided area of a plurality of divide areas around the given divided area, the position deviation amount of the first vector being relative to a predetermined reference position, the position deviation amounts of the second vectors being relative to respective predetermined reference positions, the position deviation amounts of the first and second vectors being obtained based on the above measured position information. That is, by using the above function, as described above, the nonlinear distortion of the substrate can be evaluated not depending on a rule of thumb. As a result, at least one of the correction value and the correction parameter that determines the correction value can be determined not depending on a rule of thumb, the correction value and the correction parameter corresponding to the regularity and degree of the substrate. Therefore, the piece of position information of each of the plurality of divide areas on the substrate can be accurately detected not depending on a rule of thumb, the piece of position information being used to align the divided area with respect to the predetermined point, and because the measured position information can be obtained by detecting a small number of ones out of marks on the substrate, the detection can be performed with high throughput.

There is provided a position detection method according to the first position detection method of this invention, wherein, through said statistic computation, said pieces of position information having a linear component of a position deviation amount thereof corrected are calculated for said plurality of divided areas, and wherein at least one of said correction value and said correction parameter is determined by using said function so that a nonlinear component of said position deviation amount is corrected.

There is provided a position detection method according to the first position detection method, wherein said measured position information is in accord with position deviations of said divided areas relative to said predetermined point specified in design-position information, and wherein by performing a statistic computation using said measured position information obtained from measuring at least three specific divided areas of said plurality of divided areas on said substrate, parameters of a conversion equation that calculates said pieces of position information are obtained.

In this case, There is provided a position detection method, wherein parameters of said conversion equation are calculated with said measured position information being weighted with an amount for each of said specific divided areas, and said weighting amount is determined by using said function. In this case, the weight amount can be appropriately determined not depending on a rule of thumb.

There is provided a position detection method according to the first position detection method, wherein said measured position information contains coordinates of said marks in a stationary coordinate system defining movement position of said substrate, and wherein said pieces of position information are coordinates of said divided areas in said stationary coordinate system.

There is provided a position detection method according to the first position detection method, wherein said correction values of said pieces of position information are determined based on a complement function optimized using said function.

According to a third aspect of the present invention, there is provided a first exposure method that forms a predetermined pattern on each of a plurality of divided areas on a plurality of substrates by sequentially performing exposure of said plurality of divided areas on said plurality of substrates, said exposure method comprising: detecting a piece of position information of each divided area on an n'th substrate of said plurality of substrates by using a position detection method according to the first position detection method, said n being larger than or equal to two; and performing, after having moved each of said divided areas to an exposure reference position based on said detection results, exposure on said divided area.

According to this, upon exposure of a plurality of substrates, e.g. all substrates of a lot, because position information of a plurality of divide areas on the n'th substrate of the lot is detected by using the first position detection method, the position information of the plurality of divide areas on the substrate can be accurately detected with high throughput. Moreover, because, after having moved each of the divided areas to an exposure reference position based on the detection results, exposure is performed, exposure with desirable overlay accuracy is possible. Especially, when the above position detection method is used for the n'th and later substrates, the throughput is highest.

According to a fourth aspect of the present invention, there is provided a second position detection method that detects a piece of position information to be used to align each of a plurality of divided areas on a substrate with respect to a predetermined point, wherein, for a second or later (n'th) substrate of said plurality of substrates, so as to detect a piece of position information of each of said plurality of divided areas of a plurality of substrates, are used a linear component of a piece of position information of said divided area obtained by performing a statistic computation using measured position information in accord with position deviations of at least three specific divided areas relative to said predetermined point specified in design-position information, and a nonlinear component of a piece of position information of said divided area on at least one of substrates earlier than said n'th substrate, said measured position information being measured by detecting a plurality of marks on said n'th substrate.

According to this, upon detection of position information of divided areas of a plurality of substrates, e.g. all substrates of a lot, for a second or later (n'th) substrate of the plurality of substrates of the lot, are used a linear component of a piece of position information of the divided area obtained by performing a statistic computation using measured position information in accord with position deviations of at least three specific divided areas relative to the predetermined point specified in design-position information, and a nonlinear component of a piece of position information of the divided area on at least one of substrates earlier than the n'th substrate, the measured position information being measured by detecting a plurality of marks on the n'th substrate. Therefore, for the n'th substrate, only by detecting a plurality of marks so as to obtain position information of at least three specific divided areas selected beforehand, the position information of the plurality of divide areas on the substrate can be accurately detected with high throughput. Especially, when the position information of a plurality of divide areas of each of the n'th and later substrates is obtained in the same manner as the n'th substrate, the throughput is highest.

There is provided a position detection method according to the second position detection method of this invention, wherein said nonlinear component of a piece of position information of each of said divided areas is calculated based on a single complement function optimized based on indices of regularity and degree of a nonlinear distortion, of at least one of substrates earlier than said n'th substrate, that are obtained by, through use of a predetermined evaluation function, evaluating pieces of measured position information of said divided areas on said substrate, and based on a nonlinear component of a piece of position information of said divided area on at least one of substrates earlier than said n'th substrate. In this case, the above evaluation function can be used.

In this case, there is provided a position detection method, wherein said complement function is a function expanded by the Fourier series, and wherein based on results of said evaluation a highest order of said Fourier series expansion is optimized.

There is provided a position detection method according to the second position detection method, wherein said nonlinear component of said piece of position information of each of said divided areas is calculated based on a difference between a piece of position information of said divided area, which is calculated by weighting measured position information, which is obtained by detecting a plurality of marks on said at least one of substrates earlier than said n'th substrate, and performing a statistic computation using said weighted information, and a piece of position information of said divided area calculated by performing a statistic computation using measured position information, which is obtained by detecting a plurality of marks on said at least one of substrates earlier than said n'th substrate.

According to a fifth aspect of the present invention, there is provided a second exposure method that forms a predetermined pattern on each of a plurality of divided areas on a plurality of substrates by sequentially performing exposure of said plurality of divided areas on said plurality of substrates, said exposure method comprising: detecting a piece of position information of each divided area on an n'th substrate of said plurality of substrates by using the second position detection method, said n being larger than or equal to two; and performing, after having moved each of said divided areas to an exposure reference position based on said detection results, exposure on said divided area.

According to this, upon exposure of a plurality of substrates, e.g. all substrates of a lot, because position information of a plurality of divide areas on the n'th substrate of the lot is detected by using the second position detection method, the position information of the plurality of divide areas on the substrate can be accurately detected with high throughput. Moreover, because, after having moved each of the divided areas to an exposure reference position based on the detection results, exposure is performed, exposure with desirable overlay accuracy is possible. Especially, when the above position detection method is used for the n'th and later substrates, the throughput is highest.

According to a sixth aspect of the present invention, there is provided a third position detection method that detects a piece of position information to be used to align each of a plurality of divided areas on a substrate with respect to a predetermined point, said method comprising: grouping, for a second or later (n'th) substrate of a plurality of substrates, a plurality of divided areas on said substrate into blocks beforehand based on indices representing regularity and degree of a nonlinear distortion of at least one of substrates earlier than said n'th substrate so as to detect a piece of position information of each of said plurality of divided areas of said plurality of substrates, said indices being obtained by evaluating, through use of a predetermined evaluation function, measured position information in accord with position deviations, relative to said predetermined point, of said divided areas on said at least one of substrates earlier than said n'th substrate; and determining said pieces of position information of all divided areas belonging to each of said blocks by using measured position information in accord with position deviations, relative to said predetermined point, of a second number of divided areas, said second number being smaller than a first number, which represents a total number of divided areas belonging to each of said blocks.

According to this, upon detection of position information of divided areas of a plurality of substrates, e.g. all substrates of a lot, for a second or later (n'th) substrate of the plurality of substrates of the lot, a plurality of divided areas on the substrate are grouped into blocks beforehand based on indices representing regularity and degree of a nonlinear distortion of at least one of substrates earlier than the n'th substrate, the indices being obtained by evaluating, through use of a predetermined evaluation function, measured position information in accord with position deviations, relative to the predetermined point, of the divided areas on the at least one of substrates earlier than the n'th substrate; and the pieces of position information of all divided areas belonging to each of the blocks are determined by using measured position information in accord with position deviations, relative to the predetermined point, of a second number of divided areas, the second number being smaller than a first number, which represents a total number of divided areas belonging to each of the blocks. That is, by grouping the plurality of divided areas on the n'th substrate into blocks according to regularity and degree of a nonlinear distortion thereof and, while considering the first number of divided areas of each block as a large divided area, detecting pieces of position information (including linear and nonlinear components) of one or more divided areas in each block by a method similar to the die-by-die method, position information of all divided areas in the block is obtained that is the average of the pieces of position information when the detection has been performed on more than one divided areas. Therefore, compared to the die-by-die method it is possible to shorten the time necessary for detection (measurement) while maintaining the accuracy of detecting pieces of position information of the divided areas. Especially, when the above method is used for the n'th and later substrates, the throughput is highest.

According to a seventh aspect of the present invention, there is provided a third exposure method that forms a predetermined pattern on each of a plurality of divided areas on a plurality of substrates by sequentially performing exposure of said plurality of divided areas on said plurality of substrates, said exposure method comprising: detecting a piece of position information of each divided area on an n'th substrate of said plurality of substrates by using the third position detection method, said n being larger than or equal to two; and performing, after having moved each of said divided areas to an exposure reference position based on said detection results, exposure on said divided area.

According to this, upon exposure of a plurality of substrates, e.g. all substrates of a lot, because position information of a plurality of divide areas on the n'th substrate of the lot is detected by using the third position detection method, the position information of the plurality of divide areas on the substrate can be accurately detected with high throughput. Moreover, because, after having moved each of the divided areas to an exposure reference position based on the detection results, exposure is performed, exposure with desirable overlay accuracy is possible. Especially, when the third position detection method is used for the n'th and later substrates, the throughput is highest.

According to an eighth aspect of the present invention, there is provided a fourth position detection method that detects a piece of position information to be used to align each of a plurality of divided areas on a substrate with respect to a predetermined point, said method comprising: determining a weight parameter for weighting, by using a function that is used to obtain correlation, concerning at least direction, between a first vector representing a position deviation amount of a given divided area on said substrate and second vectors each representing a position deviation amount of a divided area of a plurality of divide areas around said given divided area, said position deviation amount of said first vector being relative to a predetermined reference position, said position deviation amounts of said second vectors being relative to said predetermined reference position; and weighting measured position information, obtained by detecting a plurality of marks on said substrate, by using said weight parameter and calculating said piece of position information by a statistic computation using said weighted, measured position information.

According to this, by using the above function, as described above, the nonlinear distortion of the substrate can be evaluated not depending on a rule of thumb. As a result, the weight parameter corresponding to the regularity and degree of the substrate can be determined not depending on a rule of thumb. Therefore, the piece of position information of each of the plurality of divide areas on the substrate can be accurately detected not depending on a rule of thumb, the piece of position information being used to align the divided area with respect to the predetermined point, and because the measured position information can be obtained by detecting marks corresponding to some of the plurality of divided areas on the substrate, the detection can be performed with high throughput.

According to a ninth aspect of the present invention, there is provided a fourth exposure method that forms a predetermined pattern on each of a plurality of divided areas on a plurality of substrates by sequentially performing exposure of said plurality of divided areas on said plurality of substrates, said exposure method comprising: detecting a piece of position information of each divided area on an n'th substrate of said plurality of substrates by using the fourth position detection method, said n being larger than or equal to two; and performing, after having moved each of said divided areas to an exposure reference position based on said detection results, exposure on said divided area.

According to this, upon exposure of a plurality of substrates, e.g. all substrates of a lot, because position information of a plurality of divide areas on the n'th substrate of the lot is detected by using the fourth position detection method, the position information of the plurality of divide areas on the substrate can be accurately detected with high throughput. Moreover, because, after having moved each of the divided areas to an exposure reference position based on the detection results, exposure is performed, exposure with desirable overlay accuracy is possible. Especially, when the fourth position detection method is used for the n'th and later substrates, the throughput is highest.

According to a tenth aspect of the present invention, there is provided a fifth exposure method that forms a predetermined pattern on each of a plurality of divided areas on a substrate by sequentially performing exposure of said plurality of divided areas on said substrate, said exposure method comprising: making, for each of at least two conditions concerning said substrate, beforehand at least a correction map based on measurement results of a plurality of marks on a specific substrate, said correction map being composed of pieces of correction information used to correct nonlinear components of position deviation amounts, relative to respective reference positions, of a plurality of divided areas on said substrate; selecting a correction map corresponding to a designated condition before exposure; and calculating pieces of position information used to align each divided area with respect to a predetermined point, through use of a statistic computation, based on measured position information obtained by detecting a plurality of marks provided corresponding to each of a plurality of specific divided areas on said substrate and performing, after having moved said substrate based on said pieces of position information and said selected correction map, exposure on said divided areas.

It is noted that a “condition concerning substrates” includes conditions related to the substrates and processes thereof such as processes through which the substrates have been, the number and arrangement of alignment shot areas for substrate alignment of, e.g., the EGA method, and a reference method of the substrate alignment: a reference-substrate method, which uses a reference substrate as the reference, or an interferometer-reference method that uses an interferometer as the reference while correcting an orthogonality error, etc., due to curvature of an interferometer mirror.

According to this, first, for each of at least two conditions concerning the substrate, at least a correction map is made beforehand based on measurement results of a plurality of marks on a specific substrate, the correction map being composed of pieces of correction information used to correct nonlinear components of position deviation amounts, relative to respective reference positions, of a plurality of divided areas on the substrate.

It is noted that although a relation between the arrangement (or layout) of a plurality of marks on the specific substrate and the arrangement (or layout) of a plurality of divided areas on the specific substrate is necessary, it is not necessary to provide a mark on each of the divided areas. In other words, it is necessary that position information of the plurality of divided areas is obtained from detection results of the plurality of marks.

The nonlinear components of position deviation amounts, relative to respective reference positions (design values), of a plurality of divided areas on a substrate can be obtained based on a difference between position information, of a plurality of divided areas on a specific substrate, obtained based on measurement results of a plurality of marks on the specific substrate and position information, of the plurality of divided areas on the specific substrate, obtained from alignment of the EGA method. That is because, as described above, the EGA method calculates position information, of the plurality of divided areas on the specific substrate, having linear components of arrangement errors of the divided areas corrected and the difference between the both represents nonlinear components of the arrangement errors, i.e., position deviation amounts of the plurality of divided areas relative to respective reference positions (design values). In this case, because the correction maps with respect to the respective conditions concerning substrates are made before exposure, the throughput of the exposure is not affected.

Then when, before exposure, a condition concerning substrates is designated as the exposure condition, a correction map corresponding to the condition concerning substrates is selected. And pieces of position information used to align each divided area with respect to a predetermined point are calculated through use of a statistic computation, based on measured position information obtained by detecting a plurality of marks provided corresponding to each of a plurality of specific divided areas on the substrate, and after having moved the substrate based on the pieces of position information and the selected correction map, exposure is performed on the divided areas. That is, the pieces of position information of the divided areas which have been obtained by the above statistic computation so as to be used for alignment with respect to the predetermined point and have a linear component of a position deviation amount relative to a respective reference position corrected are corrected by using corresponding ones of the pieces of correction information contained in the selected correction map, and then after based on the pieces of position information the substrate has been moved for each of the divided areas, exposure is performed, the pieces of correction information being used to correct nonlinear components of position deviation amounts, relative to respective reference positions, of the divided areas. Therefore, highly accurate exposure having almost no overlay errors in divided areas is possible.

Therefore, according to the fifth exposure method of this invention, exposure can be performed with preventing the drop of throughput as much as possible and keeping the accuracy of overlay.

Moreover, there is provided an exposure method according to the fifth exposure method, wherein said at least two conditions include at least two process conditions through which substrates have been, wherein upon said map making, said correction map is made for each of a plurality of specific substrates that have been through different processes, and wherein upon said selection, a correction map is selected that corresponds to a substrate subject to exposure. Incidentally, the at least two process conditions through which substrates have been may be different in a condition of at least one process while the other conditions of processes such as resist coating, exposure, development and etching are the same.

There is provided an exposure method according to the fifth exposure method, wherein said at least two conditions include at least two conditions concerning selection of said plurality of specific divided areas of which said marks are detected to obtain said measured position information, wherein upon said map making, position deviation amounts relative to respective reference positions are obtained by detecting marks provided corresponding to each of a plurality of divided areas on said specific substrate wherein pieces of position information of said divided area are calculated through use of a statistic computation using measured position information obtained by detecting marks corresponding to a plurality of specific divided areas that are corresponding to said condition and are on said specific substrate, for each of said conditions concerning selection of said specific divided areas, and wherein a correction map is made based on said pieces of position information and said position deviation amounts of said divided areas, said correction map being composed of pieces of correction information used to correct nonlinear components of position deviation amounts, relative to respective reference positions, of said divided areas; and wherein upon said selection, a correction map is selected that corresponds to designated selection information of specific divided areas.

In the fifth exposure method, said specific substrate is a reference substrate or a process substrate.

Moreover, there is provided an exposure method according to the fifth exposure method, wherein upon said exposure, if divided areas on said substrate subject to exposure include an imperfect area which is in periphery of said substrate and of which a piece of correction information is not contained in said correction map, a piece of correction information of said imperfect area is calculated by a weighted-average computation based on a Gauss distribution and using pieces of correction information, contained in said correction map, of a plurality of divided areas adjacent to said imperfect area.

According to an eleventh aspect of the present invention, there is provided a sixth exposure method that forms a predetermined pattern on each of a plurality of divided areas on a substrate by sequentially performing exposure of said plurality of divided areas on said substrate, said exposure method comprising: measuring pieces of position information of mark areas each corresponding to a respective mark by detecting a plurality of marks on a reference substrate; obtaining, by a statistic computation using said pieces of measured position information, pieces of calculated position information of said mark areas each having a linear component of position deviation amount thereof, relative to a design value of a respective mark area, corrected; making a first correction map including pieces of correction information used to correct nonlinear components of position deviation amounts of said mark areas, based on said pieces of measured position information and said pieces of calculated position information, each of said position deviation amounts being relative to a design value of a respective mark area of said mark areas; converting, before exposure, said first correction map to a second correction map, based on information concerning a designated arrangement of divided areas, said second correction map including pieces of correction information used to correct nonlinear components of position deviation amounts of said divided areas, each of said position deviation amounts being relative to a reference position of a respective divided area of said divided areas; and calculating pieces of position information, used to align each divided area with respect to a predetermined point, through use of a statistic computation based on measured position information obtained by detecting a plurality of marks on said substrate and performing, while moving said substrate based on said pieces of position information and said second correction map, exposure on said divided areas.

According to this, pieces of position information of mark areas each corresponding to a respective mark are measured by detecting a plurality of marks on a reference substrate, and by a statistic computation using the pieces of measured position information, pieces of position information of the mark areas each having a linear component of position deviation amount thereof, relative to a design value of a respective mark area, corrected are calculated. Note that as the statistic computation the same computation as in the above EGA method can be used. Next, a first correction map including pieces of correction information used to correct nonlinear components of position deviation amounts of the mark areas is made based on the pieces of measured position information and the pieces of calculated position information, each of the position deviation amounts being relative to a design value of a respective mark area of the mark areas. In this case, because the first correction map is made before exposure, the throughput of the exposure is not affected.

Then, before exposure, the first correction map is converted to a second correction map, based on information concerning a designated arrangement of divided areas, the second correction map including pieces of correction information used to correct nonlinear components of position deviation amounts of the divided areas, each of the position deviation amounts being relative to a reference position of a respective divided area of the divided areas. Then, pieces of position information used to align each divided area on a substrate with respect to a predetermined point are calculated through use of a statistic computation based on measured position information obtained by detecting a plurality of marks on the substrate and while moving the substrate based on the pieces of position information and the second correction map, exposure is performed on the divided areas. That is, the pieces of position information of the divided areas which have been obtained by the above statistic computation based on the pieces of measured position information so as to be used for alignment with respect to the predetermined point and have a linear component of a position deviation amount relative to a respective reference position corrected are corrected by using corresponding ones of the pieces of correction information contained in the second correction map, and then after based on the pieces of position information the substrate has been moved for each of the divided areas, exposure is performed, the pieces of correction information being used to correct nonlinear components of position deviation amounts, relative to respective reference positions, of the divided areas. Accordingly, highly accurate exposure having almost no overlay errors in divided areas is possible.

Therefore, according to the sixth exposure method of this invention, exposure can be performed with preventing the drop of throughput as much as possible and keeping the accuracy of overlay. Especially, according to the sixth exposure method, because pieces of position information used to align each divided area on a substrate with respect to the predetermined point are corrected using pieces of correction information calculated based on measurement results of the plurality of marks on the reference substrate, all exposure apparatuses in the same device manufacturing line can be adjusted by using the reference substrate as a reference so as to improve overlay accuracy thereof. In this case, regardless of whatever information (shot map data) concerning the arrangement of divided areas on a substrate is, overlay exposure on a substrate using different ones of the exposure apparatuses can be accurately performed.

There is provided an exposure method according to the sixth exposure method, wherein in said map conversion, a piece of correction information of a reference position on each of said divided areas is calculated by a weighted-average computation assuming a Gauss distribution, based on pieces of correction information of a plurality of mark areas adjacent to said reference position. Furthermore, there is provided an exposure method according to the sixth exposure method, wherein said map conversion is realized by, for a reference position on each of said divided areas, performing a complement computation based on pieces of correction information of said mark areas and a single complement function optimized based on results of evaluating, through use of a predetermined evaluation function, regularity and degree of a nonlinear distortion of a region of a substrate.

According to a twelfth aspect of the present invention, there is provided a seventh exposure method that forms a predetermined pattern on each of a plurality of divided areas on a plurality of substrates by using a plurality of exposure apparatuses including at least one exposure apparatus capable of correcting distortion of projected image and sequentially performing exposure of said divided areas on said substrates, said exposure method comprising: an analysis step of analyzing overlay error information, measured beforehand, of at least one specific substrate that has been through the same process as said substrates; a first judgment step of judging, based on said analysis results, whether or not errors between divided areas on said specific substrate are predominant, said errors between divided areas being caused by position deviation amounts having different translation components from each other; a second judgment step of, when in said first judgment step it has been judged that said errors between divided areas are predominant, judging whether or not said errors between divided areas have a nonlinear component; a first exposure step of, when in said second judgment step it has been judged that said errors between divided areas have no nonlinear component, with using an arbitrary exposure apparatus, calculating pieces of position information used to align each divided area with respect to a predetermined point, by a statistic computation using measured position information obtained by detecting marks corresponding to each of a plurality of specific divided areas on each of said plurality of substrates and sequentially performing exposure on said plurality of divided areas of each of said plurality of substrates so as to form said pattern on each divided area, while moving said substrate based on said pieces of position information; a second exposure step of, when in said second judgment step it has been judged that said errors between divided areas have a nonlinear component, with using an exposure apparatus that can perform exposure on substrates correcting said errors between divided areas, sequentially performing exposure on said plurality of divided areas of each of said plurality of substrates so as to form said pattern on each divided area; and a third exposure step of, when in said first judgment step it has been judged that said errors between divided areas are not predominant, selecting an exposure apparatus capable of correcting distortion of said projected image and, with using said selected exposure apparatus, sequentially performing exposure on said plurality of divided areas of each of said plurality of substrates so as to form said pattern on each divided area.

According to this, overlay error information, measured beforehand, of at least one specific substrate that has been through the same process as the substrates is analyzed; based on the analysis results, it is judged whether or not errors between divided areas on the specific substrate are predominant, the errors between divided areas being caused by position deviation amounts having different translation components from each other, and when it has been judged that the errors between divided areas are predominant, it is judged whether or not the errors between divided areas have a nonlinear component.

Then when it has been judged that the errors between divided areas have no nonlinear component, with using an arbitrary exposure apparatus, pieces of position information used to align each divided area with respect to a predetermined point are calculated by a statistic computation using measured position information obtained by detecting marks corresponding to each of a plurality of specific divided areas on each of the plurality of substrates, and exposure is sequentially performed on the plurality of divided areas of each of the plurality of substrates so as to form the pattern on each divided area, while moving the substrate based on the pieces of position information. That is, when the errors between divided areas have no nonlinear component, exposure is performed while moving the substrate based on pieces of position information that are obtained by the same statistic computation as in the EGA method and used to align each divided area with respect to a predetermined point. Therefore, highly accurate exposure with overlay errors being corrected is possible.

Meanwhile, when it has been judged that the errors between divided areas have a nonlinear component, with using an exposure apparatus that can perform exposure on substrates correcting the errors between divided areas, exposure is sequentially performed on the plurality of divided areas of each of the plurality of substrates so as to form the pattern on each divided area. In this case, highly accurate exposure with overlay errors being corrected is possible.

On the other hand, when it has been judged that the errors between divided areas are not predominant, an exposure apparatus capable of correcting distortion of the projected image is selected, and with using the selected exposure apparatus, exposure is sequentially performed on the plurality of divided areas of each of the plurality of substrates so as to form the pattern on each divided area. That is, when there is almost no errors between divided areas, it is said that position deviations and/or distortions of all divided areas have almost the same amount and direction. Accordingly, by using an exposure apparatus capable of correcting distortion of the projected image, highly accurate exposure with overlay errors being corrected is possible even if the distortions are nonlinear.

As described above, according to the seventh exposure method of this invention, it is possible to perform highly accurate exposure on a plurality of substrates even if the substrates have partial distortions.

There is provided an exposure method according to the seventh exposure method, further comprising: a selection step of, when in said second judgment step it has been judged that said errors between divided areas have a nonlinear component, selecting and instructing an exposure apparatus that can perform exposure on substrates correcting said errors between divided areas to perform exposure; a third judgment step of judging how large differences of overlay errors between a plurality of lots are, said lots including a lot to which a substrate subject to exposure belongs; and

wherein in said second exposure step, when upon sequentially performing exposure on said plurality of divided areas of each of said plurality of substrates so as to form said pattern on each divided area, in said third judgment step it has been judged that differences of overlay errors between lots are large, said exposure apparatus, for each of a predetermined number of first and following substrates of said lot, calculates pieces of position information used to align each divided area with respect to a predetermined point, by a statistic computation using measured position information obtained by detecting a plurality of marks on said substrate, calculates nonlinear components of position deviation amounts, relative to respective predetermined reference positions, of said divided areas by using said measured position information and a predetermined function, and moves said substrate based on said pieces of position information calculated and said nonlinear components, and for each of the other substrates, calculates pieces of position information used to align each divided area with respect to a predetermined point, by a statistic computation using measured position information obtained by detecting a plurality of marks on said substrate, and moves said substrate based on said pieces of position information calculated and said nonlinear components calculated, and wherein when in said third judgment step it has been judged that differences of overlay errors between lots are not large, said exposure apparatus, for each substrate of said lot, calculates pieces of position information used to align each divided area with respect to a predetermined point, by a statistic computation using measured position information obtained by detecting a plurality of marks on said substrate, and moves said substrate based on said pieces of position information calculated and a correction map that is made beforehand and composed of pieces of correction information used to correct nonlinear components of position deviation amounts, relative to respective reference positions, of a plurality of divided areas on a substrate.

According to a thirteenth aspect of the present invention, there is provided an exposure apparatus that forms a predetermined pattern on each divided area on a plurality of substrates by performing exposure on said substrates, said exposure apparatus comprising: a judgment unit of judging how large differences of overlay errors between a plurality of lots are, said lots including a lot to which a substrate subject to exposure belongs; a first controller that, when said judgment unit judges that differences of overlay errors between lots are large, upon exposure for each of a predetermined number of first and following substrates of said lot, calculates pieces of position information used to align each divided area with respect to a predetermined point, by a statistic computation using measured position information obtained by detecting a plurality of marks on said substrate, calculates nonlinear components of position deviation amounts, relative to respective predetermined reference positions, of said divided areas by using said measured position information and a predetermined function, and moves said substrate based on said pieces of position information calculated and said nonlinear components, and upon exposure for each of the other substrates in said lot, calculates pieces of position information used to align each divided area with respect to a predetermined point, by a statistic computation using measured position information obtained by detecting a plurality of marks on said substrate, and moves said substrate based on said pieces of position information calculated and said nonlinear components calculated; and a second controller that, when said judgment unit judges that differences of overlay errors between lots are not large, upon exposure for each substrate of said lot, calculates pieces of position information used to align each divided area with respect to a predetermined point, by a statistic computation using measured position information obtained by detecting a plurality of marks on said substrate, and moves said substrate based on said pieces of position information calculated and a correction map that is made beforehand and composed of pieces of correction information used to correct nonlinear components of position deviation amounts, relative to respective reference positions, of a plurality of divided areas on a substrate.

According to this, before exposure of a substrate, the judgment unit judges how large differences of overlay errors between a plurality of lots are, the lots including a lot to which a substrate subject to exposure belongs. And when the judgment unit judges that differences of overlay errors between lots are large, upon exposure for each of a predetermined number of first and following substrates, the first controller calculates pieces of position information used to align each divided area with respect to a predetermined point, by a statistic computation using measured position information obtained by detecting a plurality of marks on the substrate, calculates nonlinear components of position deviation amounts, relative to respective predetermined reference positions, of the divided areas by using the measured position information and a predetermined function, and moves the substrate based on the pieces of position information calculated and the nonlinear components, and upon exposure for each of the other substrates in the lot, calculates pieces of position information used to align each divided area with respect to a predetermined point, by a statistic computation using measured position information obtained by detecting a plurality of marks on the substrate, and moves the substrate based on the pieces of position information calculated and the nonlinear components calculated. Therefore, exposure with desirable overlay accuracy can be realized while correcting position deviation amounts of divided areas that fluctuate between lots. Furthermore, for each of later ones than the predetermined number of first and following substrates, a statistic computation is performed using measured position information obtained by detecting the plurality of marks on the substrate, and based on the results of the computation and nonlinear components of position deviation amounts obtained from the predetermined number of first and following substrates, the substrate is moved for each divided area. Accordingly, exposure with high throughput is possible.

On the other hand, when the judgment unit judges that differences of overlay errors between lots are not large, upon exposure for each substrate of the lot, the second controller calculates pieces of position information used to align each divided area with respect to a predetermined point, by a statistic computation using measured position information obtained by detecting a plurality of marks on the substrate, and moves the substrate based on the pieces of position information calculated and a correction map that is made beforehand and composed of pieces of correction information used to correct nonlinear components of position deviation amounts, relative to respective reference positions, of a plurality of divided areas on a substrate. Therefore, exposure with desirable overlay accuracy can be realized while correcting position deviation amounts of divided areas that fluctuate between processes. Furthermore, because nonlinear components of position deviation amounts of the divided areas are corrected based on the correction map made beforehand, exposure with high throughput is possible.

Therefore, according to an exposure apparatus of this invention, highly accurate exposure with high throughput can be realized while correcting overlay errors that fluctuate between lots and overlay errors that fluctuate between processes.

According to a fourteenth aspect of the present invention, there is provided an eighth exposure method that forms a predetermined pattern on each of a plurality of divided areas on a substrate by performing exposure on said divided area, said exposure method comprising: selecting a first alignment mode, when, based on overlay error information of an exposure apparatus used in exposure of said substrate, errors between divided areas on said substrate are predominant, and a second alignment mode different from said first alignment mode, when errors between divided areas on said substrate are not predominant; and determining respective pieces of position information of said divided areas based on pieces of position information obtained by detecting a plurality of marks on said substrate using said selected alignment mode.

In addition, in a lithography process, by performing exposure using any of the first through eighth exposure methods of this invention, exposure with high overlay accuracy and high throughput is possible. As a result, it is possible to form finer circuit patterns on a substrate with high overlay accuracy and improve productivity (including the yield) of highly integrated micro devices. Therefore, according to another aspect of this invention there are provided device manufacturing methods using respectively the first through eighth exposure methods of this invention.

### BRIEF DESCRIPTION OF THE DRAWINGS

In the accompanying drawings;

FIG. 1 is a schematic view showing the arrangement of a lithography system related to a first embodiment according to an exposure method of the present invention;

FIG. 2 is a schematic view showing the arrangement of an exposure apparatus 100₁ in FIG. 1;

FIG. 3 is a flow chart schematically showing a control algorism of CPU in a main control system 20, which algorism is used to make a database composed of correction maps using a reference wafer, in the first embodiment;

FIG. 4 is a flow chart schematically showing a general algorism related to exposure process of wafers by the lithography system;

FIG. 5 is a flow chart showing a control algorism of CPU in the main control system 20 of the exposure apparatus 100₁, which algorism is used to perform exposure for a second or later layer on a plurality of wafers W in the same lot, in a subroutine 268 of FIG. 4;

FIG. 6 is a flow chart showing an example of a process in a subroutine 301 of FIG. 5;

FIG. 7 is a plan view of a wafer W for explaining the meaning of an evaluation function given by equation (8);

FIG. 8 is a graph showing a specific example of the evaluation function W₁(s) corresponding to the wafer in FIG. 7;

FIG. 9 is a flow chart showing a control algorism of CPU in the main control system 20 of the exposure apparatus 100₁, which algorism is used to perform exposure for a second or later layer on a plurality of wafers W in the same lot, in a subroutine 270 of FIG. 4;

FIG. 10 is a view for explaining a method of estimating nonlinear distortion in a imperfect shot area;

FIG. 11 is a graph showing an example of a Gauss distribution assumed as a distribution of weight W(rᵢ);

FIG. 12 is a flow chart briefly showing a control algorism of CPU in the main control system 20, which algorism is used to make a first correction map, in a second embodiment;

FIG. 13 is a flow chart showing a control algorism of CPU in the main control system 20 of the exposure apparatus 100₁, which algorism is used to perform exposure for a second or later layer on a plurality of wafers W in the same lot, in a subroutine 270 of the second embodiment;

FIG. 14 is a plan view of a reference wafer W_{F}1;

FIG. 15 is an enlarged view of the inside of a circle F in FIG. 14;

FIG. 16 is a flow chart showing a control algorism of CPU in the main control system 20 of the exposure apparatus 100₁, which algorism is used to perform exposure for a second or later layer on a plurality of wafers W in the same lot, in a subroutine 268 of a third embodiment;

FIG. 17 is a flow chart for explaining an embodiment of a device manufacturing method according to this invention; and

FIG. 18 is a flow chart showing an example of a specific process in a step 504 of FIG. 17.

### DETAILED DESCRIPTION OF THE PREFERRED EMBODIMENTS

<<A First Embodiment>>

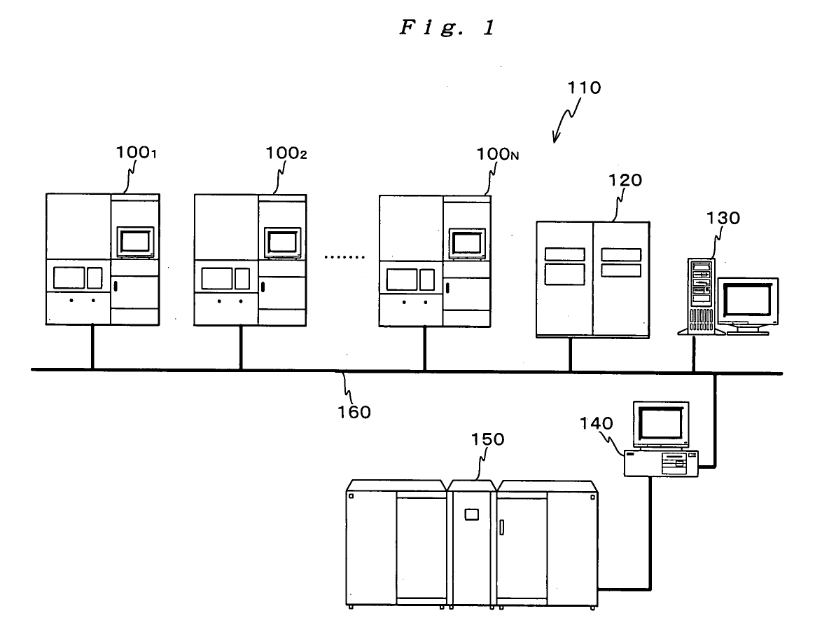

FIG. 1 shows the schematic arrangement of a lithography system 110 related to a first embodiment of this invention.

This lithography system 110 comprises N exposure apparatuses 100₁, 100₂, to 100_{N}, an overlay measurement unit 120, an central information server 130, a terminal server 140, a host computer 150, and the like. The N exposure apparatuses 100₁, 100₂, to 100_{N}, the overlay measurement unit 120, the central information server 130 and the terminal server 140 are connected to one another through a local area network (LAN) 160. In addition, the host computer 150 is connected through the terminal server 140 to the local area network (LAN) 160. That is, in terms of hard ware structure, communication paths between the exposure apparatuses 100ᵢ (i=1 to N), the overlay measurement unit 120, the central information server 130, the terminal server 140 and the host computer 150 are ensured.

Each of the exposure apparatus 100₁ through 100_{N} may be a step-and-repeat type projection exposure apparatus (a so-called “stepper”), or a step-and-scan type projection exposure apparatus (hereinafter, referred to as a “scan-type exposure apparatus”). Assume that in the below description the exposure apparatus 100₁ through 100_{N} all are a scan-type exposure apparatus having the ability of adjusting the distortion of projected images, and that especially, the exposure apparatus 100₁ is a scan-type exposure apparatus having the ability of correcting the nonlinear errors between shot areas (hereinafter, referred to as a “grid correction ability”). The structure, etc., of the exposure apparatus 100₁ through 100_{N} will be described later.

The overlay measurement unit 120, for example, measures overlay errors of first several wafers, or pilot wafers (test wafers), of each lot of a large number of lots each of which is composed of, e.g., 25 wafers, the large number of lots being continuously processed.

That is, for example, a pilot wafer having more than one layer formed thereon through processes including exposure by a predetermined exposure apparatus is put in an exposure apparatus having possibility of being used in forming the following layers, e.g. exposure apparatus 100ᵢ, and a reticle pattern (including one of sub-patterns of a registration measurement mark (overlay error measurement mark)) is transferred on the wafer. Then after the process of development and the like, the wafer is put in the overlay measurement unit 120. The overlay measurement unit 120 measures the errors (relative position errors) between respective images (e.g. resist image) of layers of the registration measurement mark formed on the wafer, and also calculates overlay-error information through use of a predetermined computation, the overlay-error information relating to the exposure apparatus having possibility of being used in forming the following layers. That is, the overlay measurement unit 120 measures the overlay-error information of pilot wafers in this manner.

The control system (not shown) of the overlay-error information communicates with the central information server 130 through LAN 160 sending and receiving data. The overlay measurement unit 120 communicates with the host computer 150 through LAN 160 and the terminal server 140, and can also communicate with the exposure apparatus 100₁ through 100_{N} through LAN 160.

The central information server 130 is composed of a mass storage unit and a processor. The mass storage unit stores exposure history data related to wafer lots. The exposure history data includes the respective overlay-error information (hereinafter, referred to as “lot-wafer-overlay-error information”) of each of the exposure apparatuses measured on pilot wafers of each lot and adjustment (correction) parameters, upon exposure for each layer, of imaging characteristics of each exposure apparatus 100ᵢ.

In this embodiment, the overlay-error information between given exposure layers, as mentioned above, is calculated by the controller of the overlay measurement unit 120 on the basis of the overlay-error information measured on pilot wafers or first several wafers of each lot, and is stored in the mass storage unit of the central information server 130.

The terminal server 140 is a gate way processor for conversion between the LAN 160's communication protocol and the host computer 150's communication protocol. Via this function of the terminal server 140 the host computer 150 can communicate with the exposure apparatus 100₁ through 100_{N} and the overlay measurement unit 120 that are connected to LAN 160.

The host computer 150 is constituted by a large-scale computer, and controls the entire wafer processing including at least a lithography process.

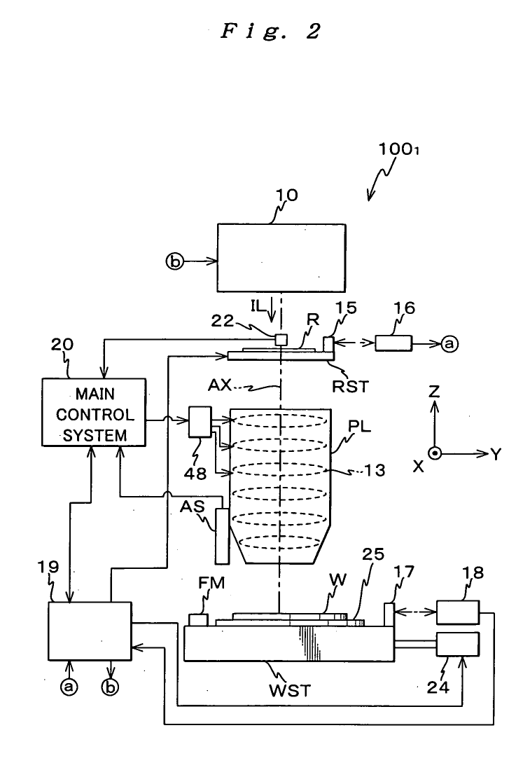

FIG. 2 shows the schematic arrangement of the exposure apparatus 100₁ that is a scan-type exposure apparatus and has a function of grid correction. The function of grid correction means correcting translation components of the position errors between a plurality of shot areas already formed on a wafer, which components are nonlinear.

The exposure apparatus 100₁ comprises an illumination system 10, a reticle stage RST holding a reticle as a mask, a projection optical system PL, a wafer stage WST on which a wafer as a substrate is mounted, a main control system 20 that controls the whole apparatus and the like.

The illumination system 10 comprises, a light source, an illuminance uniformization optical system including a fly-eye lens as an optical integrator and the like, a relay lens, a variable ND filter, a reticle blind, a dichroic mirror, and the like (none are shown) as disclosed in, for example, in Japanese Patent Laid-Open No. 10-112433, and Japanese Patent Laid-Open No. 6-349701 and U.S. Pat. No. 5,534,970 corresponding thereto. The disclosure in the above U.S. patent is incorporated herein by reference as long as the national laws in designated states or elected states, to which this international application is applied, permit.

The illumination system 10 illuminates a slit-like illumination area, on a retcile on which a circuit pattern is formed, defined by the reticle blind with illumination light IL and with almost uniform illuminace. As the illumination light IL, far ultraviolet light such as KrF excimer laser (oscillation wavelength 248 nm) or vacuum ultraviolet light such as ArF excimer laser (oscillation wavelength 193 nm) and F₂ laser (oscillation wavelength 157 nm) are used. Also ultraviolet light (g-line, i-line, etc.) from an ultra-high pressure mercury lamp can be used.

On the reticle stage RST, a reticle R is fixed by, e.g., vacuum chucking. The retilce stage RST can be finely driven in a X-Y plane perpendicular to the optical axis (coinciding with the optical axis AX of the projection optical system PL described later) of the illumination system 10 by a reticle stage driving portion (not shown) composed of, e.g., a magnetic-levitation-type, two-dimensional linear actuator so as to align the reticle, and can be driven at a designated scan speed in a predetermined scan direction (herein, it is set to be the Y-direction). Furthermore, in the present embodiment, because the magnetic-levitation-type, two-dimensional linear actuator comprises a Z-driving coil as well as a X-driving coil and a Y-driving coil, the reticle stage RST can be driven in the Z-direction.

The position of the reticle stage RST in the plane where the stage moves is detected all the time through a movable mirror 15 by a reticle laser interferometer 16 (hereafter, referred to as a “reticle interferometer”) with resolution of, e.g., 0.5 to 1 nm. The position information of the reticle stage RST from the reticle interferometer 16 is sent to a stage control system 19 and then the main control system 20, and the stage control system 19 drives the reticle stage RST through a reticle stage driving portion (not shown) on the basis of the position information of the reticle stage RST.

Above the reticle is disposed a pair of reticle alignment systems 22 (a reticle alignment system on the back side of the drawing is not shown). Each of the pair of reticle alignment systems 22 is composed of an illumination system (not shown) for illuminating a object mark with light having the same wavelength as the illumination light IL and an alignment microscope (not shown) for picking up the image of the object mark. The alignment microscope includes an imaging optical system and a pick-up device, and the results of picking up images with the alignment microscope are sent to the main control system 20. In this case, are provided deflection mirrors (not shown) for guiding detection light from the reticle to the reticle alignment systems 22, which mirrors are movable. After the exposure sequence has begun, the mirrors and the respective reticle alignment systems 22 are retracted out of the optical path of the illumination light IL by a driving unit (not shown) according to instructions of the main control system as each mirror and the respective reticle alignment system form one entity.

The projection optical system is arranged below the reticle stage RST in FIG. 1, and its optical axis AX is set to be the Z-axis direction. As the projection optical system PL, an optical reduction system that is telecentric on both sides and has a predetermined reduction ratio, e.g. 1/5, 1/4 or 1/6, is employed. Therefore, when the illumination area of the reticle R is illuminated with the illumination light IL from the illumination optical system 10, the reduced image (partially inverted image) of a circuit pattern in the illumination area on the reticle is formed on a wafer W coated with resist (photosensitive material) via the projection optical system PL by the illumination light IL having passed the reticle R.

As the projection optical system, as shown in FIG. 1, a refraction optical system composed of a plurality of, e.g. 10 to 20, refraction optical elements (lens elements) 13 is used. A plurality of lens elements on the object side (reticle side) out of the plurality of lens elements 13 composing the projection optical system are ones that can be moved in the Z-direction (the optical axis direction of the projection optical system PL) and rotated about the X and Y directions by driving elements (not shown) such as piezo devices. And according to instructions from the main control system 20, an image-characteristic-correction controller 48 drives individual movable lenses by adjusting applied voltages to the respective driving elements, and adjusts various imaging characteristics (reduction ratio, distortion, astigmatism, coma, image field curvature, etc.) of the projection optical system PL. Note that the image-characteristic-correction controller 48 can shift the center wavelength of the illumination light IL by controlling the light source, and adjust the imaging characteristics by the shift of the center wavelength as well as by the displacement of the movable lenses.

The wafer stage WST is provided on a base BS below the reticle stage RST in FIG. 1, and a wafer holder 25 is mounted on the wafer stage WST. On this wafer holder 25, the wafer W is fixed by, e.g., vacuum chuck or the like. The wafer holder 25 is so structured that it can be tilted in any direction with respect to a plane perpendicular to the optical axis of the projection optical system PL and can be finely moved in the direction of the optical axis AX (the Z-direction) of the projection optical system PL by a driving portion (not shown). The wafer holder 25 can also rotate finely about the optical axis AX.

The wafer stage WST is so structured that it can move not only in the scan direction (the Y-direction) but also in a direction perpendicular to the scan direction (the X-direction) so that a plurality of shot areas on the wafer can be positioned at an exposure area conjugate to the illumination area, and a step-and-scan operation is performed in which an operation of performing scan-exposure to each shot area on the wafer and an operation of moving the wafer to the starting position of a next shot area are repeated. The wafer stage WST is driven in the X-Y, two-dimensional direction by, e.g., a wafer-stage driving portion 24 including a linear motor.

The position of the wafer stage WST in the X-Y plane is detected all the time through a movable mirror 17, provided on the upper surface thereof, by a wafer laser interferometer system 18 with resolution of, e.g., 0.5 to 1 nm. In practice, on the wafer stage WST are arranged a Y-movable mirror having a reflection surface perpendicular to the scan direction (the Y-direction) and a X-movable mirror having a reflection surface perpendicular to the non-scan direction (the X-direction), and corresponding to those mirrors, a Y-interferometer sending out an interferometer beam perpendicular to the Y-movable mirror and a X-interferometer sending out an interferometer beam perpendicular to the X-movable mirror are provided as the wafer laser interferometer system 18. However, these are represented by the movable mirror 17 and the wafer laser interferometer system 18 in FIG. 1. That is, in this embodiment a stationary coordinate system (an orthogonal coordinate system) that defines the movement position of the wafer stage WST is defined by measurement axes of the Y- and X-interferometers of the wafer laser interferometer system 18. Hereinafter, the stationary coordinate system is also referred to as a “stage coordinate system”. Note that by mirror processing of the end surface of the wafer stage WST the reflection surfaces for the interferometer beams may be formed.

The position information (or velocity information) of the wafer stage WST in the stage coordinate system is sent to the stage control system 19 and then the main control system 20. And on the basis of the position information (or velocity information), the stage control system 19 controls the wafer stage WST through the wafer stage driving portion 24.

In addition, near the wafer W on the wafer stage WST is fixed a reference mark plate FM. The surface of the reference mark plate FM is set to be at the same height as that of the surface of the wafer W, and on the surface are formed a reference mark for so-called base line measurement of an alignment system described later, a reference mark for reticle alignment, and other reference marks.

On the side of the projection optical system PL is an off-axis method alignment system AS. As the alignment system AS is used an alignment sensor of a Field Image Alignment (FIA) system disclosed in, for example, in Japanese Patent Laid-Open No. 2-54103 and U.S. Pat. No. 4,962,318 corresponding thereto. The disclosure in the above U.S. patent is incorporated herein by reference as long as the national laws in designated states or elected states, to which this international application is applied, permit.

The alignment system AS sends out illumination light (white light) having a predetermined range of wavelength onto a wafer, has the image of an alignment mark on the wafer and the image of an index mark on an index plate, disposed in a plane conjugate to the wafer, imaged on the light-receiving surface of the pick-up device (such as CCD) through an object lens and detects those images. The alignment system AS outputs to the main control system 20 the pick-up results of the alignment mark and the reference marks on the reference mark plate FM.

The exposure apparatus 100₁ further comprises an illumination optical system (not shown) sending out an imaging beam, for forming a plurality of slit images, toward the best image plane of the projection optical system PL and in an oblique direction with respect to the optical axis AX direction, and a multi-focal detection system of an oblique incident method constituted by receiving optical system (not shown) for receiving through respective slits individual reflection beams, of the imaging beam, reflected by the wafer surface, the illumination optical system and multi-focal detection system being fixed on a support portion (not shown) supporting the projection optical system PL. As the multi-focal detection system, is used a system having the same structure as ones disclosed in, for example, in Japanese Patent Laid-Open No. 5-190423, and Japanese Patent Laid-Open No. 6-283403 and U.S. Pat. No. 5,448,332 corresponding thereto. The stage control system 19 moves the wafer holder 25 in the Z-direction and tilts it on the basis of the wafer position information from the multi-focal detection system. The disclosure in the above U.S. patent is incorporated herein by reference as long as the national laws in designated states or elected states, to which this international application is applied, permit.

The main control system 20 comprises a microcomputer or work station, and controls all elements of the apparatus, and is connected to the above LAN 160. In addition, in this embodiment a storage unit of the main control system 20 such as a hard disk or RAM (memory) has various kinds of correction maps, prepared beforehand as a database, stored therein.

Other exposure apparatuses 100₂ to 100_{N} have the same arrangement as the exposure apparatus 100₁ except for part of algorism of the main control system.

Next, the procedure of making the correction maps will be described briefly. The procedure of making the correction maps includes two main steps of: A. preparing a reference wafer as a specific substrate; B. measuring marks on the reference wafer and making a database on the basis of the measurement results of the marks.

A. Preparing a Reference Wafer

The reference wafer is prepared by the procedure described below with omitting some details.

First, a thin layer of silicon dioxide (or silicon nitride, poly-silicon) is formed on an entire surface of silicon-substrate (wafer), and the silicon dioxide layer is covered with a photosensitive material (resist) by a resist coating unit (coater, not shown). Then while the coated substrate is loaded onto the wafer holder of a reference exposure apparatus (e.g., the most reliable scanning-stepper in the same device manufacturing line), a reference-wafer reticle (a special reticle having an enlarged reference mark pattern formed thereon) is loaded onto the reticle stage, and the pattern of the reference-wafer reticle is reduced and transferred onto the silicon-substrate according to a step-and-scan method.

In this way, onto a plurality of shot areas on the silicon-substrate is transferred the reference mark pattern (a wafer alignment mark for aligning a wafer in production, including a search alignment mark and a fine alignment mark), and it is preferable for the number of the shot areas to be the same as that of wafers for production.

Next, the silicon-substrate already exposed is unloaded from the wafer holder, and is developed by a developer (not shown). In this way, resist images of the reference mark pattern are formed on the silicon-substrate surface.

Next, on the silicon-substrate already developed is performed an etching process of exposing portions of the silicon surface by an etching unit (not shown), and then residual resist on the silicon-substrate surface is removed by, e.g., a plasma ashing apparatus.

In this manner, the reference wafer having shallow holes on the silicon dioxide layer, corresponding to the reference mark (wafer alignment mark), formed on each of the plurality of shot areas is created, the shot areas having the same arrangement as wafers in production.

Note that a reference wafer is not limited to the above wafer, which has marks formed on the silicon dioxide layer thereof by patterning, and that a reference wafer may be used that has shallow holes, corresponding to marks, formed on the silicon surface thereof. Such a reference wafer can be prepared in the following manner.

First, the silicon substrate is covered with a photosensitive material (resist) by a resist coating unit (coater; not shown). Then the coated silicon substrate is loaded onto the wafer holder of a reference exposure apparatus in the same way as the above, and the pattern of the reference-wafer reticle is reduced and transferred onto the silicon-substrate according to a step-and-scan method.

Next, the silicon-substrate already exposed is unloaded from the wafer holder, and is developed by a developer (not shown). In this way, resist images of the reference mark pattern are formed on the silicon-substrate surface. Then on the silicon-substrate already developed is performed an etching process of carving portions of the silicon surface by an etching unit (not shown), and then residual resist on the silicon-substrate surface is removed by, e.g., a plasma ashing apparatus.

In this manner, the reference wafer having shallow holes on the silicon substrate surface, corresponding to the reference mark (wafer alignment mark), formed on each of the plurality of shot areas is created, the shot areas having the same arrangement as wafers in production

Because the reference wafer is used to manage the accuracy of a plurality of exposure apparatuses in the same device manufacturing line, if the plurality of exposure apparatuses use a plurality of shot-map data (each shot-map datum containing the size of a shot area and arrangement of shot areas of a different wafer), it is preferable to prepare respective reference wafers for the shot-map data.

B. Making a Database

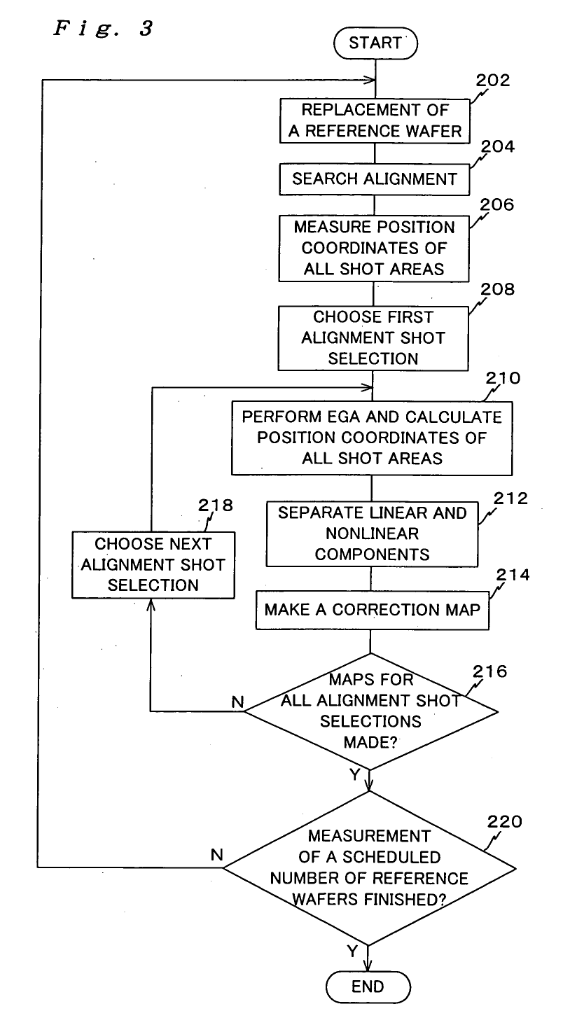

Next, an operation of making a database composed of correction maps by using the reference wafer prepared in the above manner will be described with reference to a flow chart of FIG. 3 schematically showing the control algorism of a CPU in the main control system 20 provided in the exposure apparatus 100₁.

As a premise it is assumed that an exposure condition setting file referred to as a process program file, selection information concerning alignment-shot-areas (a plurality of specific shot areas (alignment-shot-areas) selected upon wafer alignment of an EGA method), information concerning shot-map data and the like are stored in a predetermined area of RAM (not shown) beforehand.

First, in a step 202 if there is a wafer, which may be a reference wafer, on the wafer holder 25 in FIG. 1, the wafer is replaced with a new reference wafer by a wafer loader (not shown), and if not, a new reference wafer is merely loaded onto the wafer holder 25. The new reference wafer is a wafer having the arrangement, of shot areas, corresponding to a first shot map datum stored in a predetermined area of the RAM.

In a step 204, search alignment is performed on the reference wafer loaded onto the wafer holder 25. Specifically, for example, at least two search alignment marks (hereinafter, a “search mark” for short) located at positions, in the wafer periphery, almost symmetric with respect to the wafer center are detected by an alignment system AS. These two search marks are detected with the magnification of the alignment system AS set to be low and by sequentially positioning the wafer stage WST such that each of the search marks is placed within the detection sight of the alignment system AS. Then the position, in the stage coordinate system, of the two search marks are calculated based on detection results (relative position relation between the index center of the alignment system AS and search marks) and measurement values of the wafer interferometer 18 upon detection of each search mark. Then a residual rotation error of the reference wafer is calculated based on the position-coordinates of the search marks, and the wafer holder 25 is finely rotated so that the residual rotation error becomes almost zero. This is the end of search alignment of the reference wafer.

In a step 206, position-coordinates, in the stage coordinate system, of all shot areas on the reference wafer are measured. Specifically, in the same manner as position measurement of each search mark in the above search alignment, are detected position-coordinates, in the stage coordinate system, of fine alignment marks (wafer marks) on the wafer W, i.e. position-coordinates of the shot areas. Note that the wafer marks are detected with the magnification of the alignment system AS set to be high.

In a step 208 is selectively read out first alignment-shot-area information stored in a predetermined area of the RAM.

In a step 210, based on position-coordinates, of alignment-shot-areas designated by the first information read out in the step 208, out of the position-coordinates of the shot areas measured in the step 206 and based on respective position-coordinates in terms of design, is performed a statistical computation using the least square method (EGA computation by the above equation (2)) disclosed in Japanese Patent Laid-Open No. 61-44429 and U.S. Pat. No. 4,780,617 corresponding thereto, and six parameters a to f in the above equation (1) are calculated, the six parameters corresponding respectively to rotation θ, scaling Sx and Sy in the X and Y directions, orthogonal degree Ort and offsets Ox and Oy in the X and Y directions, which all are related to the arrangement of each shot area. And then based on the calculation results and the position-coordinates in terms of design of each shot area, position-coordinates (arrangement coordinates) of all shot areas are calculated and the calculation results, i.e. the position-coordinates of all shot areas on the reference wafer are stored in a predetermined area of the RAM. The disclosure in the above U.S. patent is incorporated herein by reference as long as the national laws in designated states or elected states, to which this international application is applied, permit.

A step 212 separates a linear component and nonlinear component of position deviation amount for each shot area on the reference wafer. Specifically, a difference between the position-coordinate for the shot area calculated in the step 210 and a respective position-coordinate in terms of design is calculated and taken as the linear component. And a difference between the position-coordinate measured in the step 206 for the shot area and the respective position-coordinate in terms of design is calculated, and the difference minus the linear component is taken as the nonlinear component.

A step 214 generates a correction map that includes a respective nonlinear component, calculated in the step 212, as a piece of correction information for correcting the arrangement deviation of each shot area, and corresponds to the shot-map datum for the reference wafer (here, the first reference wafer) and the alignment-shot-areas selected in the step 208.

In a step 216 it is tested if correction maps for all alignment-shot-area selections specified by data contained in the predetermined area of the RAM are made, and if the answer is NO, the sequence advances to a step 208, and next alignment-shot-area information stored in the RAM is selected and read out. After that, the steps 210 to 216 are repeated. After correction maps for all alignment-shot-area selections for the shot-map datum of the first reference wafer has been completed in this manner, the answer in the step 216 is YES, the sequence advances to a step 220.

A step 220 determines based on information regarding all shot-map data stored in the predetermined area of the RAM if a predetermined number of reference wafers have been measured. If the answer is No, the sequence returns to the step 202, and after the reference wafer has been replaced with a next reference wafer, the same process as the above is repeated.

After correction maps for all scheduled alignment shot area selections for all scheduled reference wafers, i.e. for all shot-map data, have been made in this manner, the answer in the step 220 is YES, and the whole process of this routine ends. In this manner, in the RAM are stored correction maps each composed of pieces of correction information each of which is used for correcting nonlinear component of position deviation amount of a respective shot area relative to a respective reference position (e.g. an ideal position in terms of design), the correction maps composing a database for all sets of a shot-map datum and an alignment-shot-area selection, which sets may be used by the exposure apparatus 100₁. Note that although the step 212 has separated the linear component and nonlinear component of position deviation amount for each shot area by using position-coordinates measured in the step 206, position-coordinates in terms of design and position-coordinates calculated in the step 210, only the nonlinear component may be calculated without separating the linear and nonlinear components. In this case, a difference between the position-coordinate for each shot area measured in the step 206 and the respective position-coordinate calculated in the step 210 may be taken as the nonlinear component. Furthermore, if the rotation error of the wafer W is within a permissible range, search alignment in the step 204 may be omitted.

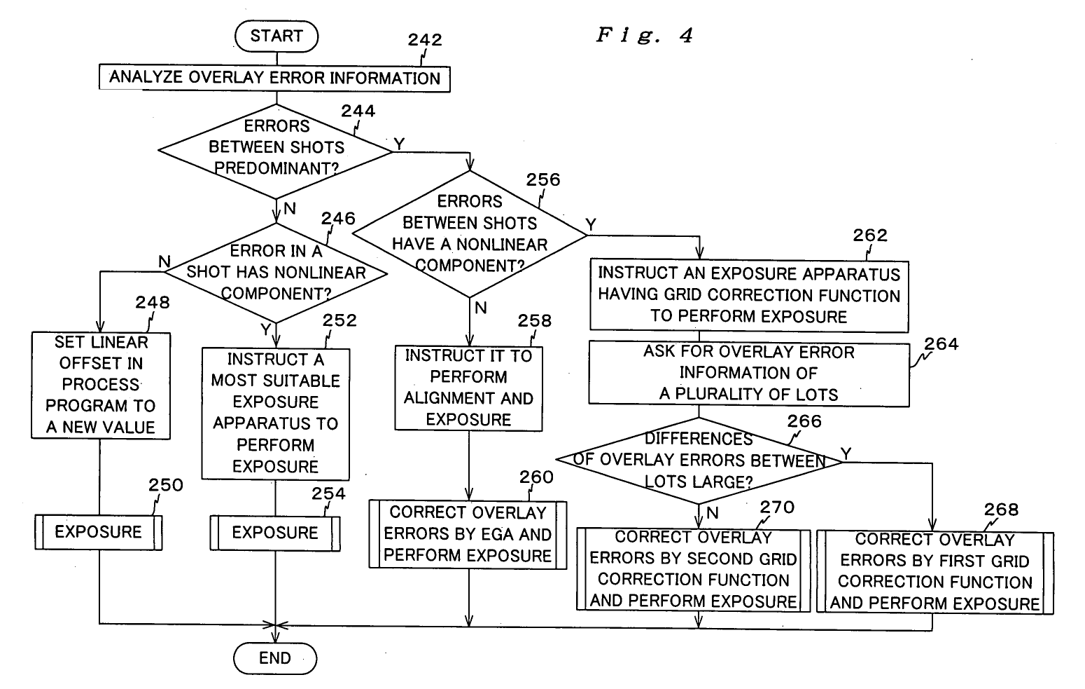

Next, an algorism of wafer exposure process by the lithography system 110 according to this embodiment will be described with reference to FIGS. 4 to 9.

FIG. 4 schematically shows the algorism of wafer exposure process by the lithography system 110.

As a premise of executing the algorism of wafer exposure process it is assumed that a wafer W as an exposure object has more than one layer formed by exposure and that exposure-history data, etc., of the wafer are stored in the central information server 130, and it is also assumed that overlay error information of a pilot wafer of the same lot, which information was measured by the overlay measurement unit 120, is also stored in the central information server 130, the pilot wafer having been through the same process as the wafer W.

First, in a step 242, the host computer 150 reads out and analyzes overlay error information of wafers of the lot, as an exposure object lot, from the central information server 130.

In a step 244, the host computer 150 checks based on the analysis results if an error between shots is predominant. The error between shots means a position error that exists between shot areas already formed on the wafer W and includes a translation component. Therefore, if position errors between shot areas on the wafer W include little of deformation components due to heat expansion of the wafer, due to differences between stage grids (differences between exposure apparatuses), and due to wafer process, the answer in the step 244 is No, otherwise YES.

And if the answer in the step 244 is YES, the sequence advances to a step 256. In the step 256 the host computer 150 determines whether or not the error between shots includes the nonlinear component.

If the answer in the step 256 is YES, the sequence advances to a step 262. In the step 262 the host computer 150 selects an exposure apparatus having a grid correction function (in this embodiment, the exposure apparatus 100₁), and instructs it to set an exposure condition thereof and perform exposure.

In a step 264, through LAN 160 the main control system 20 of the exposure apparatus 100₁ asks the central information server 130 for overlay error information of wafers of a plurality of lots including lots before and after the exposure object lot, which information is related to the exposure apparatus 100₁. And in a step 266, the main control system 20 determines by comparing differences of overlay errors between consecutive lots to a predetermined threshold on the basis of the overlay error information of wafers of the plurality of lots from the central information server 130 whether or not the differences of overlay errors are large. If the answer in the step 266 is YES, the sequence advances to a subroutine 268 of correcting the overlay errors by using a first grid correction function and performing exposure.

In this subroutine 268, the exposure apparatus 100₁ performs exposure process on wafers W of the exposure object lot in the following manner.

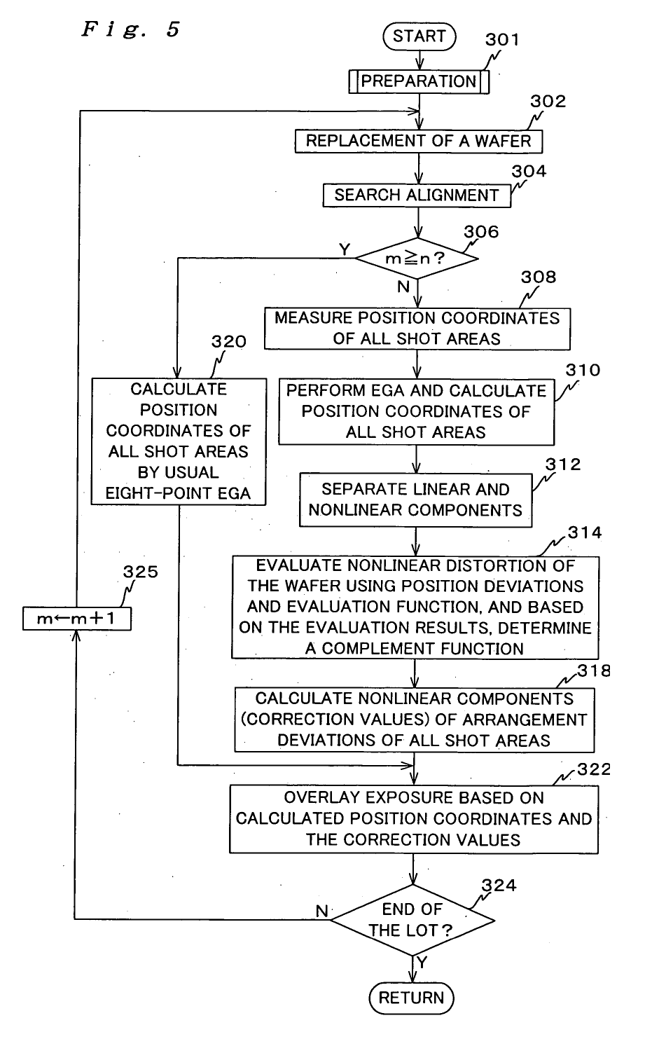

FIG. 5 shows a control algorism in the subroutine 268, of the CPU of the main control system 20, which performs exposure process for the second and later layers on a plurality of wafers (e.g., 25 wafers) in the same lot. Next, the process in the subroutine 268 will be described with reference to the flow chart in FIG. 5 and other figures as necessary.

As a premise it is assumed that all wafers in the lot have been through the same process with the same conditions and that a counter (not shown) indicating a wafer number (m) in the lot has been set to one. The wafer number will be described later.

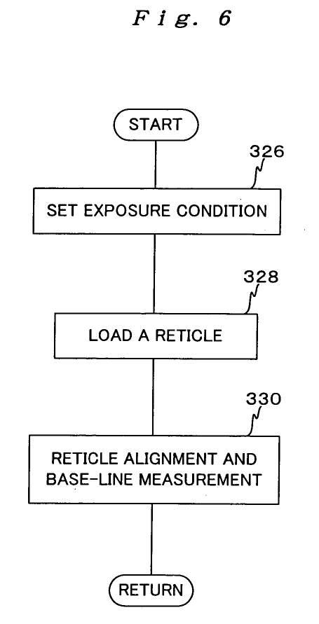

A subroutine 301 performs a predetermined preparation. A step 326 in FIG. 6 selects a process program file (a file for setting an exposure condition) corresponding to a setting-instruction information for an exposure condition, given by the host computer 150 upon instructing it to perform exposure, and sets an exposure condition according to the file.

In a step 328 a reticle loader (not shown) loads a reticle R onto the reticle stage RST.

A step 330 performs base-line measurement by using the reticle alignment systems and alignment system AS. Specifically, the main control system 20 positions the wafer stage WST through the wafer stage driving portion 24 such that the reference mark plate FM thereon is placed straightly below the projection optical system PL, and after having detected positions of a pair of reticle alignment marks on the reticle respectively relative to a pair of corresponding first reference marks on the reference mark plate FM by using the reticle alignment systems 22, the main control system 20 moves the wafer stage by a predetermined amount, e.g. design value of base-line, in the X-Y plane, and detects second reference marks for base-line measurement on the reference mark plate FM by using the alignment system AS. In this case the main control system 20 measures base-line amount (relative position relation between the projection position of the reticle pattern and the detection center (index center) of the alignment system AS) on the basis of the relative position relation, between the detection center of the alignment system AS and the second reference marks, and the measured positions of the reticle alignment marks relative to the first reference marks on the reference mark plate FM, and based on measurement values of the wafer interferometer 18 corresponding to the relative position relation and the measured positions.

In this manner after the base-line measurement by the reticle alignment systems and alignment system AS has finished, the sequence returns to a step 302 in FIG. 5.

In the step 302 the wafer loader (not shown) replaces the wafer already exposed (from here on, referred to as ‘W′’) on the wafer holder 25 in FIG. 1 with a wafer W not yet exposed. Note that if there is not the wafer W′, a wafer W not yet exposed is merely loaded onto the wafer holder 25.

A step 304 performs search alignment on the wafer W loaded onto the wafer holder 25. Specifically, for example, at least two search alignment marks (hereinafter, a “search mark” for short) located at positions, in the wafer periphery, almost symmetric with respect to the wafer center are detected by an alignment system AS. These two search marks are detected with the magnification of the alignment system AS set to be low and by sequentially positioning the wafer stage WST such that each of the search marks is placed within the detection sight of the alignment system AS. Then the position coordinates, in the stage coordinate system, of the two search marks are calculated based on detection results (relative position relation between the index center of the alignment system AS and search marks) and measurement values of the wafer interferometer 18 upon detection of each search mark. Then a residual rotation error of the wafer W is calculated based on the position-coordinates of the search marks, and the wafer holder 25 is finely rotated so that the residual rotation error becomes almost zero. This is the end of search alignment of the wafer W.

A step 306, by checking if the value m of the counter is larger or equal to a predetermined number n, checks if the wafer W on the wafer holder 25 (wafer stage WST) is an n'th or later in the lot. The n is an arbitrary number between 2 and 25 inclusive, and from here on, for the sake of convenience it is assumed that the n is equal to two. In this case, because the wafer W is the first wafer of the lot (m=1), the answer in the step 306 is NO, and the sequence advances to a step 308.

In a step 308, position-coordinates, in the stage coordinate system, of all shot areas on the wafer W are measured. Specifically, in the same manner as position measurement of each search mark in the above search alignment, are detected position-coordinates, in the stage coordinate system, of fine alignment marks (wafer marks) on the wafer W, i.e. position-coordinates of the shot areas. Note that the wafer marks are detected with the magnification of the alignment system AS set to be high.

In a step 310, based on the position-coordinates of the shot areas measured in the step 308 and respective position-coordinates in terms of design, a statistical computation using the least square method (EGA computation by the above equation (2)) is performed, and six parameters a to f in the above equation (1) are calculated, the six parameters corresponding respectively to rotation θ, scaling Sx and Sy in the X and Y directions, orthogonal degree Ort and offsets Ox and Oy in the X and Y directions, which all are related to the arrangement of each shot area. And then based on the calculation results and the position-coordinates in terms of design of each shot area, position-coordinates (arrangement coordinates) of all shot areas are calculated and the calculation results, i.e. position-coordinates of all shot areas on the reference wafer are stored in a predetermined area of the RAM.

A step 312 separates a linear component and nonlinear component of position deviation amount for each shot area on the wafer W. Specifically, a difference between the position-coordinate for each shot area calculated in the step 310 and the respective position-coordinate in terms of design is calculated and taken as the linear component. And a difference between the position-coordinate measured in the step 308 for the shot area and the respective position-coordinates in terms of design is calculated, and the difference minus the linear component is taken as the nonlinear component.

A step 314 evaluates nonlinear distortion of the wafer W based on position deviation amounts of all shot areas each of which is the difference between the position-coordinate (measured value) for each shot area and the respective position-coordinate in terms of design, which difference was calculated in the step 312, and a predetermined evaluation function. Then based on the evaluation results, the step 314 determines a complement function representing the nonlinear components of the position deviation amounts (arrangement deviations).

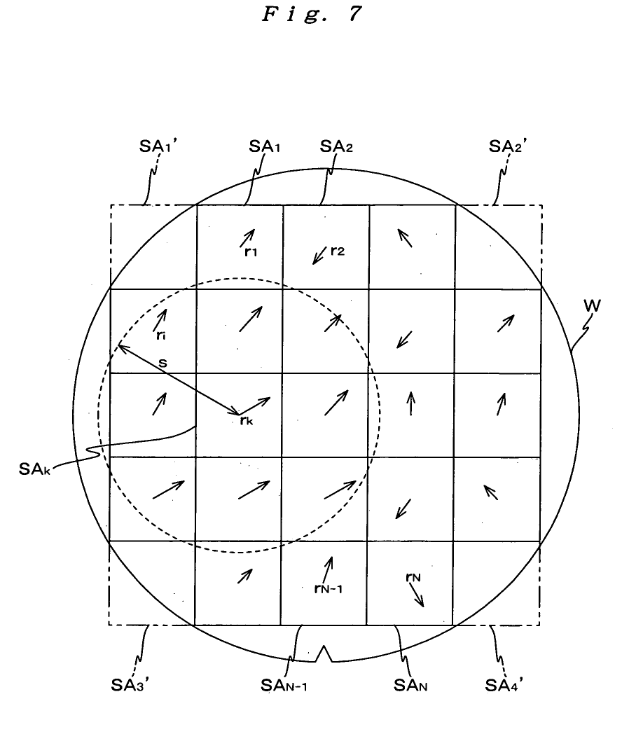

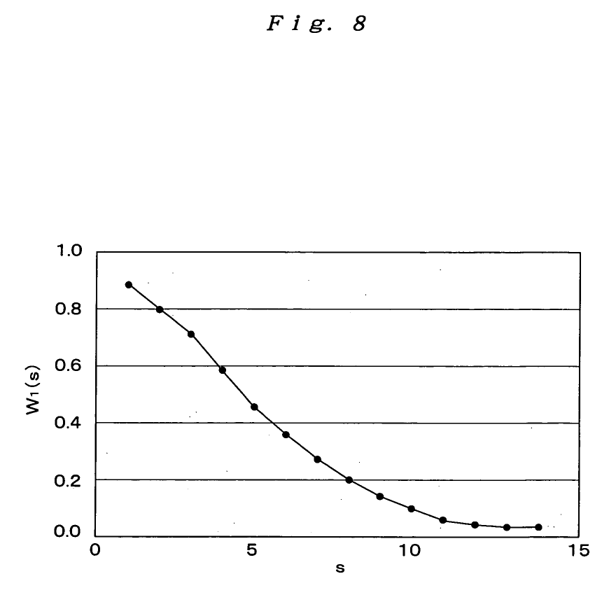

Next, the process of the step 314 will be described in detail with reference to FIGS. 7 and 8.

As such an evaluation function for evaluating nonlinear distortion of a wafer W, i.e. regularity and degree of the nonlinear distortion, is used an evaluation function W₁(s) given by, e.g., the following equation (8):

$${W}_{1} ( s ) = \frac{{\sum }_{k = 1}^{N} ( \frac{{\sum }_{i ∈ s} \frac{{{r}_{i}}^{->} \cdot {{r}_{k}}^{->}}{\vert {r}_{i} ‖ {r}_{k} \vert}}{{\sum }_{i ∈ s} 1} )}{N} \qquad ( 8 )$$

FIG. 7 shows a plan view of the wafer W for explaining the meanings of the evaluation function given by the equation (8). In FIG. 7, a plurality of shot areas SA as divided areas (the total shot number=N) are arranged on the wafer W in a matrix-shape, and vectors rₖ (k=1 to i to N) symbolized by arrows each represent the position deviation amount (arrangement deviation) of the respective shot area.

In the equation (8), N represents the total number of shot areas on the wafer W, and ‘k’ represents the shot number of a shot area. In addition, in FIG. 7 ‘s’ represents the radius of a circle of which the center coincides with the center of a shot area SAₖ that is now under consideration and ‘i’ represents the shot number of a shot area located in the circle for the shot area SAₖ. Furthermore, Σ of the equation (8), to which “iεs” is attached, means the total sum for all shot areas in the circle for the shot area SAₖ.

The function in the square bracket in the right side of the equation (8) is defined as

$${f}_{k} ( s ) = \frac{{\sum }_{i ∈ s} \frac{{{r}_{i}}^{->} \cdot {{r}_{k}}^{->}}{\vert {r}_{i} ‖ {r}_{k} \vert}}{{\sum }_{i ∈ s} 1} \qquad ( 9 )$$

The function fₖ(s) of the equation (9) means the average of values cos θᵢₖ, θᵢₖ being an angle between the position deviation amount vector rₖ (the first vector) of the shot area and the position deviation amount vector rᵢ of another shot area in the circle for the shot area SAₖ. Therefore, the value of the function fₖ(s) being equal to one means that all position deviation amount vectors in the circle for the shot area SAₖ are in the same direction, and the value of the function fₖ(s) being equal to zero means that all position deviation amount vectors in the circle for the shot area SAₖ have completely random directions. That is, the function fₖ(s) is a function for calculating direction-correlation between the position deviation amount vector rₖ of the shot area SAₖ and the position deviation amount vectors rᵢ of a plurality of other shot areas around the shot area, and an evaluation function for evaluating regularity and degree of the nonlinear distortion on part of the wafer W.

Accordingly, the evaluation function Wₗ(s) given by the (8) is the average of the function fₖ(s)'s values, of shot areas SA₁ through SA_{N}, which are obtained by changing a shot area under consideration sequentially between shot areas SA₁ through SA_{N}.

FIG. 8 shows an example of the evaluation function Wₗ(s) corresponding to the wafer W in FIG. 7. As seen in FIG. 8, according to the evaluation function Wₗ(s) the regularity and degree of the nonlinear distortion of the wafer can be evaluated not depending on a rule of thumb because the value of Wₗ(s) varies depending on the value of s. By using the evaluation results a complement function representing the nonlinear components of the position deviation amounts (arrangement deviations) can be determined in the following manner.

First, as such a complement function, a pair of functions which are given by, e.g., the following equations (10) and (11), and which are expanded by the Fourier series is defined.

$$\begin{matrix}{δ}_{x} ( x , y ) = {\sum }_{p = 0}^{P} {\sum }_{q = 0}^{Q} ( {A}_{\dot{pq}} cos \frac{2 π px}{D} \cdot cos \frac{2 π qy}{D} + {B}_{pq} cos \frac{2 π px}{D} \cdot sin \frac{2 π qy}{D} + {C}_{pq} sin \frac{2 π px}{D} \cdot cos \frac{2 π qy}{D} + {D}_{pq} sin \frac{2 π px}{D} \cdot sin \frac{2 π qy}{D} ) \\ {A}_{pq} = \frac{{\sum }_{x , y} {Δ}_{x} ( x , y ) \cdot cos \frac{2 π px}{D} \cdot cos \frac{2 π qy}{D}}{{\sum }_{x , y} cos \frac{2 π px}{D} \cdot cos \frac{2 π qy}{D}} \\ {B}_{pq} = \frac{{\sum }_{x , y} {Δ}_{x} ( x , y ) \cdot cos \frac{2 π px}{D} \cdot sin \frac{2 π qy}{D}}{{\sum }_{x , y} cos \frac{2 π px}{D} \cdot sin \frac{2 π qy}{D}} \\ {C}_{pq} = \frac{{\sum }_{x , y} {Δ}_{x} ( x , y ) \cdot sin \frac{2 π px}{D} \cdot cos \frac{2 π qy}{D}}{{\sum }_{x , y} sin \frac{2 π px}{D} \cdot cos \frac{2 π qy}{D}} \\ {D}_{pq} = \frac{{\sum }_{x , y} {Δ}_{x} ( x , y ) \cdot sin \frac{2 π px}{D} \cdot sin \frac{2 π qy}{D}}{{\sum }_{x , y} sin \frac{2 π px}{D} \cdot sin \frac{2 π qy}{D}} & ( 10 ) \\ {δ}_{y} ( x , y ) = {\sum }_{p = 0}^{P} {\sum }_{q = 0}^{Q} ( {A}_{pq}^{′} cos \frac{2 π px}{D} \cdot cos \frac{2 π qy}{D} + {B}_{pq} cos \frac{2 π px}{D} \cdot sin \frac{2 π qy}{D} + {C}_{pq} sin \frac{2 π px}{D} \cdot cos \frac{2 π qy}{D} + {D}_{pq} sin \frac{2 π px}{D} \cdot sin \frac{2 π qy}{D} ) \\ {A}_{pq}^{′} = \frac{{\sum }_{x , y} {Δ}_{y} ( x , y ) \cdot cos \frac{2 π px}{D} \cdot cos \frac{2 π qy}{D}}{{\sum }_{x , y} cos \frac{2 π px}{D} \cdot cos \frac{2 π qy}{D}} \\ {B}_{pq}^{′} = \frac{{\sum }_{x , y} {Δ}_{y} ( x , y ) \cdot cos \frac{2 π px}{D} \cdot sin \frac{2 π qy}{D}}{{\sum }_{x , y} cos \frac{2 π px}{D} \cdot sin \frac{2 π qy}{D}} \\ {C}_{pq}^{′} = \frac{{\sum }_{x , y} {Δ}_{y} ( x , y ) \cdot sin \frac{2 π px}{D} \cdot cos \frac{2 π qy}{D}}{{\sum }_{x , y} sin \frac{2 π px}{D} \cdot cos \frac{2 π qy}{D}} \\ {D}_{pq}^{′} = \frac{{\sum }_{x , y} {Δ}_{y} ( x , y ) \cdot sin \frac{2 π px}{D} \cdot sin \frac{2 π qy}{D}}{{\sum }_{x , y} sin \frac{2 π px}{D} \cdot sin \frac{2 π qy}{D}} & ( 11 )\end{matrix}$$

In the equation (10), A_{pq}, B_{pq}, C_{pq}, D_{pq} are Fourier series coefficients, and δₓ(x, y) represents the X-component of the nonlinear component (a complement value, i.e. a correction value) of the position deviation amount (arrangement deviation) of the shot area having a coordinate (x, y), and Δₓ(x, y) represents the X-component of the nonlinear component of the position deviation amount (arrangement deviation) of the shot area having a coordinate (x, y), which nonlinear component was calculated in the step 312.

Furthermore, in the equation (11), A_{pq}′, B_{pq}′, C_{pq}′, D_{pq}′ are Fourier series coefficients, and δ_{y}(x, y) represents the Y-component of the nonlinear component (a complement value, i.e. a correction value) of the position deviation amount (arrangement deviation) of the shot area having a coordinate (x, y), and Δ_{y}(x, y) represents the Y-component of the nonlinear component of the position deviation amount (arrangement deviation) of the shot area having a coordinate (x, y), which nonlinear component was calculated in the step 312. Moreover, in the equations (10) and (11), D represents the diameter of the wafer W.

In the equations (10) and (11), it is important to determine maximum values pₘₐₓ(=P), qₘₐₓ(=Q) of the parameter p, q that determine how many periods of fluctuation of position deviation amount (arrangement deviation) of shot areas there are over the wafer diameter.

The reason for that will be described in the following. That is, consider having the calculated nonlinear components of arrangement deviations of all shot areas in the wafer W expressed by the equations (10) and (11). Then, assuming that position deviation amounts (arrangement deviation) are different between shot areas, the maximum values pₘₐₓ(=P), qₘₐₓ(=Q) of the parameter p, q are set to values corresponding to the period that is equal to the shot pitch. And then, consider that there is a so-called “jump shot”, of which the alignment error is large compared with the other shot areas. Such a jump shot is caused by measurement errors due to defects of wafer marks or by local, nonlinear distortion due to foreign matters on the back of a wafer. To prevent the complement function from including the measurement result of the jump shot, it is necessary to set the P and Q to values smaller than the values corresponding to the period that is equal to the shot pitch. That is, it is suitable to have the complement function include only low frequency components with excluding high frequency components due to the jump shot.

Therefore, in this embodiment maximum values pₘₐₓ(=P), qₘₐₓ(=Q) of the parameter p, q are determined by using the evaluation function W₁(s) given by the (8). Because, if any, a jump shot has little correlation with other shot areas around it, the measurement result of the jump shot does not increase the value of the evaluation function W₁(s) given by the (8), and therefore it is possible to reduce or remove the effect of the jump shot by using the equation (8). That is, it is considered that the correlation between shot areas in a circle having a radius s of a value at which W₁(s) in FIG. 8 is larger than 0.7 is strong and that it is appropriate to express such a circle area by one complement value. According to FIG. 8 such a value of the radius s is three. By using this value (s=3) and thus the wafer diameter D the P, Q are expressed as follows:

P=D/s=D/3, Q=D/s=D/3 (12).

By this, the most suitable values for P, Q have been determined, and thus the complement function of the equations (10), (11) can be determined.

In a step 318 by computing the complement function of the equations (10), (11) by using the X-component Δₓ(x, y) and the Y-component Δ_{y}(x, y) of the nonlinear component, calculated in the step 312, of the position deviation amount (arrangement deviation) of the shot area having a coordinate (x, y), are obtained the X-component and the Y-component of the nonlinear component (a complement value, i.e. a correction value) of the arrangement deviation for each shot areas on the wafer W. And the sequence advances to a step 322.

The step 322, based on the arrangement coordinates of all shot areas stored in the predetermined area of the internal memory and the correction values, calculated in the step 318, of the nonlinear components of the position deviations, a corrected overlay position having the position deviation amount (linear and nonlinear components) corrected is calculated for each shot area. And in the step 322, the following two operation are repeated to perform exposure of the step-and-scan type: based on the corrected overlay position and a base-line amount measured beforehand, each time a different shot area on the wafer W is moved to the acceleration-start position (scan-start position) by stepping; and a reticle pattern is transferred on the wafer while synchronously moving the reticle stage RST and wafer stage WST. By this, exposure process for the first wafer W of the lot ends.

A step 324, by checking if the value m of the counter is larger than 24, checks if exposure for all wafers in the lot has finished. Because, now, m is equal to one, the answer is No, and the sequence advances to a step 325. Then the counter is incremented by one (m←m+1), and the sequence returns to the step 302.

In the step 302 the wafer loader (not shown) replaces the first wafer already exposed on the wafer holder 25 with a second wafer W in the lot.

The step 304 performs search alignment on the wafer W (the second wafer in the lot) on the wafer holder 25 in the same manner as the above.

The step 306, by checking if the value m of the counter is larger or equal to a predetermined number n (=2), checks if the wafer W on the wafer holder 25 (wafer stage WST) is the second or later in the lot. Because, now, the wafer W is the second wafer of the lot (m=2), the answer in the step 306 is YES, and the sequence advances to a step 320.

In the step 320, according to the usual eight-point EGA, position-coordinates of all shot areas on the wafer W are calculated. Specifically, by using the alignment system AS in the same way as the above, wafer marks on eight shot areas (sample shot areas, i.e. alignment shot areas), selected beforehand, on the wafer W are measured, and position-coordinates, in the stage coordinate system, of the sample shot areas are calculated. And based on the calculated position-coordinates of the sample shot areas and respective position-coordinates in terms of design, a statistical computation using the least square method (EGA computation by the above equation (2)) is performed, and six parameters in the above equation (1) are calculated. Then based on the calculation results and the position-coordinates in terms of design of all shot areas, position-coordinates (arrangement coordinates) of all shot areas are calculated; the calculation results are stored in a predetermined area of the internal memory, and the sequence advances to a step 322.

In the step 322, in the same manner as the above, exposure process for the second wafer W in the lot is performed according to the step-and-scan method. Before moving the wafer W to the acceleration-start position (scan-start position) of each shot area by stepping, based on the arrangement coordinates of all shot areas stored in the predetermined area of the internal memory and the correction values, calculated in the step 318, of the nonlinear component of the position deviation, the step 322 calculates a corrected overlay position for each shot area, which has the position deviation amount (linear and nonlinear components) corrected.

After exposure for the second wafer W in the lot has ended in the above manner, the sequence advances to a step 324, and it is checked if exposure for all wafers in the lot has ended. Now, the answer is NO, and the sequence returns to the step 302. After that, until exposure for all wafers in the lot has ended, the process from the step 302 to the step 324 is repeated.

If exposure for all wafers in the lot has ended, and the answer in the step 324 is YES, the sequence returns from the subroutine in FIG. 5 to FIG. 4, and the whole process ends.

On the other hand, if the answer in the step 266 is NO, the sequence advances to a subroutine 270 where overlay errors are corrected by using a second grid correction function.

In the subroutine 270 the exposure apparatus 100₁ performs exposure process on wafers W in the lot in the following manner.

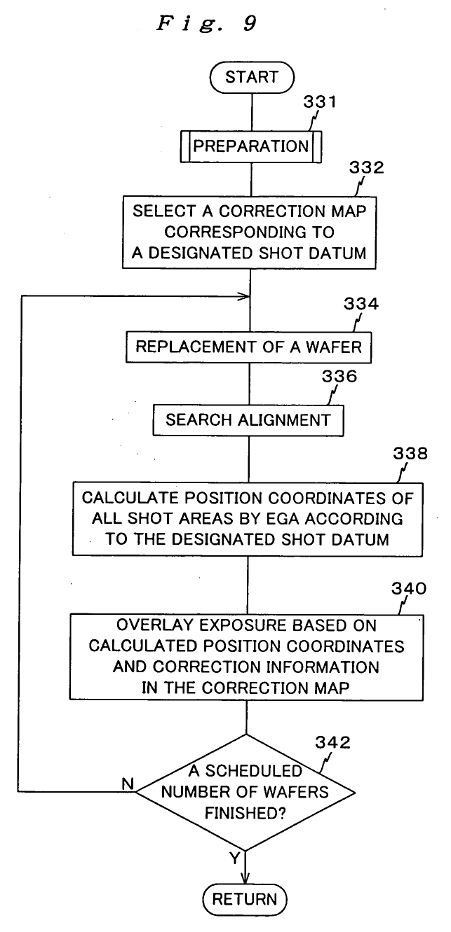

FIG. 9 shows a control algorism of the CPU in the main control system 20 for performing exposure process of the second or later layer on a plurality of wafers (e.g. 25 wafers) in the same lot. The process in the subroutine 270 will be described with reference to the flow chart in FIG. 9 and other figures as necessary.

As a premise it is assumed that all wafers in the lot have been through the same process with the same conditions.

First, after a subroutine 331 has performed a predetermined preparation in the same way as in the subroutine 301, the sequence advances to a step 332. The step 332 selectively reads out a correction map corresponding to a shot map datum and shot datum such as information for selecting alignment shot areas, which are contained in a process program file selected upon the above preparation, from the database in the RAM on the basis of setting-instruction information, for an exposure condition, given by the host computer 150 upon instructing the exposure apparatus 100₁ to perform exposure in the step 262, and stores the correction map temporarily in the internal memory.

In a step 334 the wafer loader (not shown) replaces the wafer already exposed (from here on, referred to as ‘W′’) on the wafer holder 25 in FIG. 1 with a wafer W not yet exposed. Note that if there is not the wafer W′, a wafer W not yet exposed is merely loaded onto the wafer holder 25.

A step 336 performs search alignment on the wafer W on the wafer holder 25 in the same manner as the above.

In the step 338, according to the shot map datum and shot datum such as information for selecting alignment shot areas, wafer alignment of the EGA method is performed in the same manner as the above, and position-coordinates of all shot areas on the wafer W are calculated and stored in a predetermined area of the internal memory.

A step 340, based on the arrangement coordinates of all shot areas stored in the predetermined area of the internal memory and the correction values (correction information) of the nonlinear component of the position deviation amount of each corresponding shot area in the correction map temporarily stored in the internal memory, is calculated a corrected overlay position for each shot area, which has the position deviation amount (linear and nonlinear components) corrected. And in the step 322, the following two operation are repeated to perform exposure of the step-and-scan type: based on the corrected overlay position and a base-line amount measured beforehand, each time a different shot area on the wafer W is moved to the acceleration-start position (scan-start position) by stepping; and a reticle pattern is transferred on the wafer while synchronously moving the reticle stage RST and wafer stage WST. By this, exposure process for the first wafer W of the lot ends.

In a step 342 it is checked if exposure for a scheduled number of wafers has ended. If the answer is NO, the sequence returns to the step 334. After that, the above process is repeated.

If exposure for a scheduled number of wafers has ended, and the answer in the step 342 is YES, the sequence returns from the subroutine in FIG. 9 to FIG. 4, and the whole process ends.

On the other hand if the answer in the step 256 is NO, i.e. if errors between shot areas have only linear components (wafer magnification error, wafer orthogonal degree error, wafer rotation error, etc.), the sequence advances to a step 258. In the step 258 the host computer 150 instructs the main control system of the exposure apparatus 100ⱼ to perform EGA wafer alignment and exposure, the exposure apparatus 100ⱼ having been designated beforehand.

After in a subroutine 260 the exposure apparatus 100ⱼ has performed the predetermined preparation in the same way as the above, EGA wafer alignment and exposure is performed on a wafer of the lot according to a predetermined procedure, which exposure is highly accurate with overlay errors due to position errors (linear component) between shot areas already formed on the wafer being corrected.

On the other hand if the answer in the step 244 is NO, i.e. if errors within shot areas are predominant, the sequence advances to a step 246. In the step 246 the host computer 150 checks whether or not the errors within shot areas have a nonlinear component, specifically whether or not the errors within shot areas include an error other than linear components such as wafer magnification error, shot orthogonal degree error and shot rotation error. If the answer in the step 246 is NO, the sequence advances to a step 248. In the step 248 the host computer 150 updates linear offset (wafer magnification error, shot orthogonal degree error and shot rotation error) in a next exposure condition setting file (a process program file) to be used by the exposure apparatus 100ⱼ on the basis of the analysis result in the step 242, the exposure apparatus 100ⱼ having been designated beforehand and performing exposure on wafers in the lot.

After that, the sequence advances to a subroutine 250. In the subroutine 250 the exposure apparatus 100ⱼ performs exposure process in the same way as the usual scanning-stepper and according to the process program file of which the linear offset has been updated. Note that because the subroutine 250 is just the same as the usual, a detailed explanation is omitted. After that, this routine ends.

Meanwhile, if the answer in the step 246 is YES, the sequence advances to a step 252. In the step 252 the host computer 150 selects an exposure apparatus (now, 100ₖ is selected) having the most suitable image-distortion-correction capability for the lot among the exposure apparatuses 100₁ through 100_{N}, and instructs the exposure apparatus 100ₖ to perform exposure. To select the most suitable exposure apparatus, a method disclosed in Japanese Patent Laid-Open No. 2000-36451 may be used.

That is, the host computer 150, first, designates the identification of the lot (e.g., the lot number) as an overlay exposure object and one or more layers already exposed (hereinafter, referred to as a “reference layer”) for which overlay accuracy should be ensured, and asks the central information server 130 for overlay error data and adjustment parameters (correction parameters) of imaging characteristic through the terminal server 140 and LAN 160. The central information server 130, according to the identification of the lot and the reference layer, reads out the overlay error data, of the lot, between the reference layer and a next layer, and adjustment parameters (correction parameters) of imaging characteristic of the exposure apparatus 100ᵢ for exposure of the lot from exposure history information recorded in the mass storage unit, and sends them to the host computer 150.

Next, based on the above various pieces of information, for each exposure apparatus 100ᵢ, the host computer 150 calculates values of adjustment parameters of imaging characteristic, which values make the overlay error, of the lot, between the reference layer and the next layer minimum within the imaging-characteristic-adjustment capability, and a residual overlay error (residual error after correction) upon using the values of the adjustment parameters.

Then the host computer 150 compares each residual error after correction and a predetermined allowable error limit, and selects exposure apparatuses having the residual error below a predetermined allowable error limit as candidates for exposure of the lot. Next, with reference to the current operation states and operation schedules of the candidates the host computer 150 selects an exposure apparatus for exposure of the lot that is most suitable for efficient lithography process.

After that, the sequence advances to a subroutine 254. In the subroutine 254 the selected exposure apparatus adjusts the imaging characteristic of the projection optical system so that the residual error after correction becomes as small as possible, and performs exposure process in the same way as the usual scanning-stepper. Note that because the subroutine 254 is just the same as that of the usual scanning-stepper having an imaging-characteristic-correction mechanism, a detailed explanation is omitted. After that, this routine ends. Note that the host computer 150 may instruct the main control system of the selected exposure apparatus to adjust the imaging characteristic of the projection optical system so that the residual error after correction becomes as small as possible, and that an image-distortion computing unit may be provided which the main control system of the selected exposure apparatus, with designating the identifications of the lot and itself, makes to compute adjustment parameters values of projected image's distortion upon exposure of a wafer of the lot.

As described above, according to this embodiment, based on the detection results of a plurality of reference marks provided on each of a plurality of shot areas of a reference wafer, a correction map composed of pieces of information each of which is for correcting the nonlinear component of a position deviation, relative to a respective reference position (design value), of each of a plurality of shot areas on a wafer (process wafer) is created for each condition of selecting alignment shot areas, which condition may be used by the exposure apparatus 100₁.

When creating the correction map, for each of the plurality of shot areas on the reference wafer, a piece of position information of the shot area obtained by detecting reference marks on the shot area, that is, a position deviation amount relative to the respective reference position (design value) is calculated (step 206). Next, by, for each condition for selecting alignment shot areas, performing statistic computation (EGA computation) based on measured position information obtained by detecting reference marks on a plurality of alignment shot areas corresponding to the condition, a piece of position information, having a linear-component of the position deviation amount corrected, of each shot area on the reference wafer is calculated, and based on the pieces of position information and pieces of reference position information of all shot areas, and based on the position deviation amounts of all shot areas, is made the correction map that is composed of pieces of information each for correcting a nonlinear component of the position deviation amount of a respective shot area relative to its reference position (design value). The calculation and making are performed in the steps 210 to 214.

Furthermore, in this embodiment after reference wafers corresponding to respective shot map data that may be used by the exposure apparatus 100₁ have been prepared, for each reference wafer and for each condition of selecting alignment shot areas, which condition may be used by the exposure apparatus 100₁, a correction map composed of pieces of information each of which is for correcting the nonlinear component of a position deviation, relative to a respective reference position (design value), of each of a plurality of shot areas on a wafer (process wafer) is created. Then the correction maps are stored in the RAM of the main control system 20.

In this manner a plurality of correction maps are made. However, because the correction maps are made before exposure, it does not affect the throughput of exposure.

Next, if the host computer 150 determines based on measurement results of overlay errors of pilot wafers that errors between shots are predominant (in the steps 242, 244), and that it is difficult to correct overlay errors only by wafer alignment of the EGA method, the host computer 150 designates an exposure condition and instructs the exposure apparatus 100₁ to perform exposure, in the steps 256, 262. Then the main control system 20 of the exposure apparatus 100₁ determines how large differences of overlay errors between lots are (in the steps 264, 266), and if the differences of overlay errors between lots are small, the sequence advances to the subroutine 270. In the subroutine 270 the main control system 20 selects a correction map for a shot map datum and alignment shot areas that are part of the designated exposure condition (in the step 332). In addition, by performing statistic computation (EGA computation) based on measured position information obtained by detecting wafer marks on a plurality of alignment shot areas on the wafer, the main control system 20 calculates position information for alignment between shot areas and a reticle-pattern-projection-position, the alignment shot areas being at least three specific shot areas designated by an exposure condition, and after based on the position information and the selected correction map, each shot area on the wafer has been moved to an acceleration start position (exposure reference position), scan-exposure is performed on the shot area (in the steps 338, 340).

That is, according to this embodiment each piece of position information, having the linear component of a position deviation amount relative to the reference position (design value) of a respective shot area corrected, for alignment between the shot area and the reticle-pattern-projection-position is corrected based on a respective piece of correction information contained in the selected correction map, and after based on the piece of corrected position information the shot area on the wafer has been moved to the acceleration start position, exposure is performed on the shot area. Therefore, because exposure on each shot area is performed after the shot area has been accurately moved to a position obtained by correcting both linear and nonlinear components of the position deviation, accurate exposure with almost no overlay errors is possible.

Moreover, if the main control system 20 determines that differences of overlay errors between lots are large, the sequence advances to the subroutine 268. In the subroutine 268, upon exposure of a second, or later, wafer in the lot the main control system 20 corrects the linear components of the arrangement deviations of shot areas on the wafer W based on measurement results of the usual eight-point EGA, and, assuming the second and later wafers having the same nonlinear components as the first wafer, uses corresponding values for the first wafer as correction values to correct the nonlinear components of the arrangement deviations of the shot areas (in the steps 320, 322). Accordingly, the throughput can be improved compared with the case of performing all-point EGA on all wafers of the lot because of reduced measurement points.

Furthermore, in the subroutine 268 by introducing the above evaluation function, a nonlinear distortion of a wafer W can be evaluated not relying on a rule of thumb but based on a definite ground. And based on the evaluation results a nonlinear component of the position deviation amount (arrangement deviation) of each shot area can be calculated, and based on the calculation result and a linear component of the arrangement deviation of the shot area calculated by EGA, the arrangement deviation (including both the linear and nonlinear components) of the shot area and thus a corrected position for overlay can be accurately calculated (in the steps 308 to 322). While based on the corrected positions for overlay the shot areas are consecutively moved to the acceleration-start position (scan-start position) by stepping, a reticle pattern is transferred onto each shot area. Accordingly, each shot area on the wafer can be accurately aligned with the reticle pattern.

On the other hand if the host computer 150 determines based on measurement results of overlay errors of pilot wafers that errors between shots are not predominant (in the steps 242, 244), the host computer 150, depending on whether or not errors between shot areas have a nonlinear component, selects the most suitable exposure apparatus which makes residual errors, after correction, of a projection image minimal, or sets a linear offset in the process file to a new value. And exposure according to the process file having a new linear offset or exposure by the selected exposure apparatus is performed in the same manner as the usual.

Therefore, according to this embodiment exposure can be performed with preventing the drop of throughput as much as possible and keeping the accuracy of overlay. As seen in the above explanation, according to the lithography system 110 and the exposure method of this embodiment, it is possible for another exposure apparatus to accurately align each shot area of a wafer, onto which a pattern of a first layer has been already transferred by the reference exposure apparatus in the same device manufacturing line, with another reticle pattern. That is, according to this embodiment it is possible to minimize overlay errors due to grid errors between stages of exposure apparatuses. Especially, errors between shots that fluctuate between lots can be accurately corrected by the process of the subroutine 268, and errors between shots that fluctuate due to change of shot maps or selection of alignment shots can be accurately corrected by the process of the subroutine 270.

Although the above embodiment described the case where reference wafers as specific substrates are prepared to measure marks and to generate correction maps and where a condition for making a correction map designates a shot map datum and selection of alignment areas, this invention is not limited to this. That is, for each condition designating a shot map datum or for each condition designating selection of alignment areas a correction map may be made.

Moreover, as specific substrates, process wafers for production may be used. In this case such conditions can include at least two process conditions through which the wafers have undergone. In this case, instead of the step 332, by making correction maps for all process wafers in the same manner as in the steps 202 through 220 and, before exposure of a wafer, selecting the correction map corresponding to the wafer, the same effect as the above embodiment can be achieved. That is, even in this case exposure can be performed with preventing the decrease of throughput as much as possible and keeping the accuracy of overlay. In this case it is possible to correct errors due to the wafer process.

Although in the subroutine 268 it is described that eight-point EGA is performed on the second or later wafer in the lot, the number of measurement points (alignment marks) for EGA can be any number larger than the number of unknown parameters calculated in the statistical computation, which number is six in this embodiment.

In addition, in this embodiment there may be a case where although imperfect shot areas exist among shot areas in the wafer periphery (so-called edge-shot areas), the correction map does not include a piece of correction information for the imperfect shot areas because there is no necessary mark thereon.

In this case, it is preferable to estimate nonlinear distortion in the imperfect shot areas by a statistical computation. A method for estimating nonlinear distortion in an imperfect shot area will be described in the following.

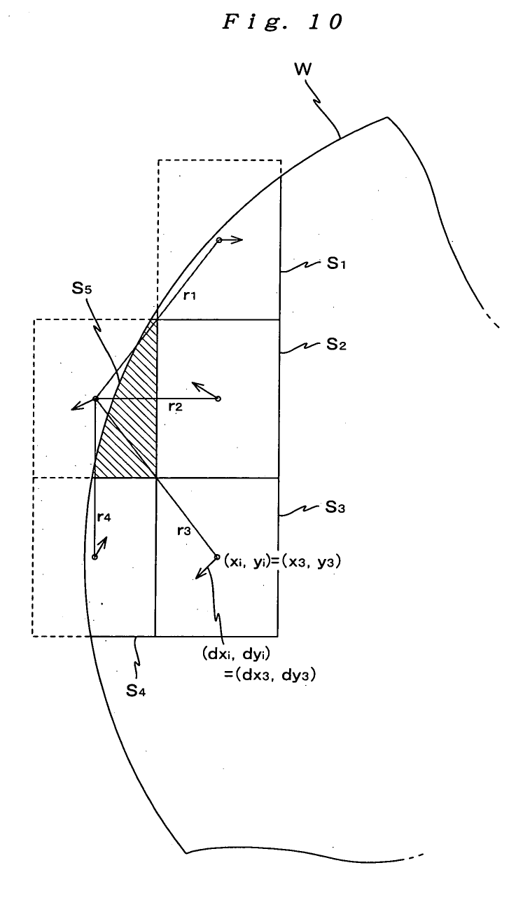

FIG. 10 shows part of periphery of a wafer W. In FIG. 10 is shown a nonlinear distortion component (dxᵢ, dyᵢ) in a correction map calculated in the above manner. It is assumed that because a shot area S₅ of the reference wafer has no reference mark, correction information (nonlinear distortion component) thereof was not obtained upon making the correction map. Under such premise it is also assumed that the shot map datum designated upon exposure includes information for shot area S₅.

The main control system 20 performs EGA-wafer-alignment based on designated alignment-shot-area information, and calculates coordinates (xᵢ, yᵢ) of centers of all shot areas, including the shot area S₅, on the wafer W. Then the main control system 20 calculates correction information (Δx, Δy) for the shot area S₅ using, e.g., the following equations (13), (14)

$$\begin{matrix}Δ x = \frac{\sum ⅆ {x}_{i} \times W ( {r}_{i} )}{n} & ( 13 ) \\ Δ y = \frac{\sum ⅆ {y}_{i} \times W ( {r}_{i} )}{n} & ( 14 )\end{matrix}$$

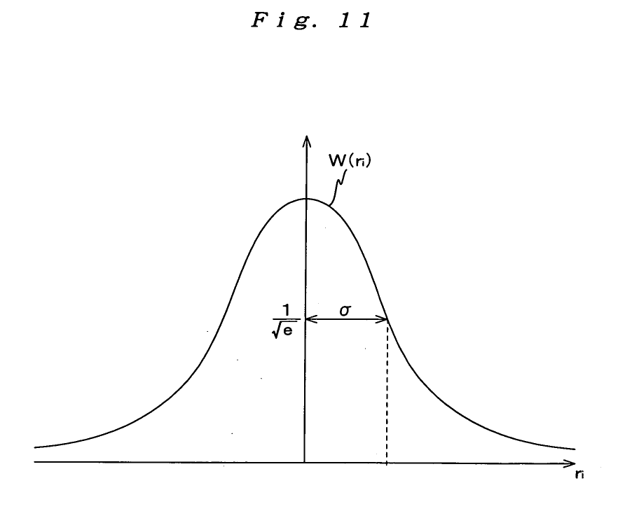

In the above equations (13), (14), rᵢ (i=1 through 4) represent the distances between the shot area S₅ and adjacent shot areas (S₁, S₂, S₃, S₄). W(rᵢ) represents a weight assumed for a Gauss distribution in FIG. 11, of which the standard deviation σ is about the distance between adjacent shot areas (the step pitch).

In this way, based on correction information (Δx, Δy) and position information of imperfect shot areas like the shot area S₅, which position information is obtained in the above wafer alignment, each imperfect shot area on the wafer is moved to the acceleration start position (exposure reference position), and exposure is performed. Therefore, a retcile pattern can be transferred even onto imperfect shot areas with desirable overlay accuracy.

Furthermore, consider that exposure is performed even on, for example, imperfect shot areas SA₁′ through SA₄′ indicated by virtual lines in FIG. 7. In this case, even if EGA measurement is not performed in any of the imperfect shot areas, nonlinear components of their position deviation amounts as well as linear components can be corrected by performing the process of the subroutine 268 and using the correction function.

In the above embodiment, the host computer 150 automatically analyzes overlay error information, determines if errors between shots are predominant, updates the linear offset of the process file, selects the most suitable exposure apparatus, and determines, if the errors between shots are predominant, whether or not they have a nonlinear component. However, an operator may perform this process instead of the host computer 150.

Furthermore, in this embodiment the main control system 20 (CPU) of the exposure apparatus 100₁ determines if differences of overlay errors between lots are large, and depending on the results, the sequence advances to the subroutine 268 or 270. However, this invention is not limited to this. That is, the host computer 150 may be provided with modes to select the processes of the subroutines 268, 270 respectively, and an operator may determine based on measurement results of the overlay measurement unit if the differences of overlay errors between lots are large and based on the result, select one of the modes.

In addition, upon exposure of the first wafer of the lot in the subroutine 268, based on shot arrangement coordinates calculated and based on measurement results of wafer marks of all shot areas, by EGA computation and nonlinear components of arrangement coordinates' deviations calculated by using the correction function, each shot area is positioned at the scan start position. However, based on each shot area's position deviation amount measured in the step 308, the shot area may be positioned at the scan start position without EGA computation.

Moreover, in this embodiment if n is an integer larger than or equal to three, on first (n−1) wafers in the lot, the process from the steps 308 through 318 is repeated. At this time, in the step 318, for any of the second through (n−1) wafers, nonlinear components (correction values) of arrangement deviations of all shot areas may be calculated based on, for example, the average of the computation results prior to the wafer. Needless to say, also for the n'th or later wafer the average of nonlinear components of at least two wafers of the first (n−1) wafers may be used.

Note that the above evaluation function is just an example, and that the following evaluation function W₂(s) may be used in place of the evaluation function given by (8).

$${W}_{2} ( s ) = \frac{{\sum }_{k = 1}^{N} ( \frac{{\sum }_{i ∈ s} \frac{{{r}_{i}}^{->} \cdot {{r}_{k}}^{->}}{{\vert {r}_{k} \vert}^{2}}}{{\sum }_{i ∈ s} 1} )}{N} \qquad ( 15 )$$

According to the equation (15), direction and size correlations between the position deviation amount vector rₖ (first vector) of a shot area under consideration and position deviation amount vectors rᵢ (second vectors) of shot areas around it (within a circle of radius s) can be calculated. According to the evaluation function W₂(s) regularity and degree of wafer nonlinear distortion can be usually evaluated more accurately than the above embodiment. Note that because the evaluation function of the equation (15) takes the size into account, the accuracy of the evaluation may decrease depending on the deviation, etc., of position deviation amounts of shot areas, although it rarely happens.

Therefore, by calculating a value of radius s at which both the evaluation functions W₁(s) and W₂(s) (equations (8), (15)) show high correlation, i.e., both are close to one, the wafer nonlinear distortion may be evaluated, and the value of s can be used in determining the correction function.

Furthermore, the step 314 in the above first embodiment may be omitted. That is, nonlinear components of position deviation amounts separated in the step 312 may be used as nonlinear components (correction values) of respective position deviation amounts of shot areas in the step 322.

Moreover, although in the step 312 a nonlinear component and a linear component of a respective position deviation amount of each shot area are separated based on a respective position coordinate measured in the step 308, a respective position coordinate on design and a respective position coordinate calculated in the step 310, only the nonlinear component may be calculated without the separation. In this case the difference between the position coordinate measured in the step 308 and the position coordinate calculated in the step 310 can be considered the nonlinear component. In addition, the search alignment of the step 304 of FIG. 5 and the step 336 of FIG. 9 may be omitted if the rotation error of the wafer W is within a permissible range. Moreover, although in the step 262 of FIG. 4 an exposure apparatus is selected, if an exposure apparatus to be used has the grid correction functions, one of the grid correction functions may be selected according to the determination in the step 266 with omitting the step 262.

Although the above embodiment describes the case where the exposure apparatus 100₁ has both the first and second grid correction functions, the exposure apparatus may have only one of the two. That is, omitting the step 266 the step 268 or 270 may be performed.

Furthermore, in the above embodiment, the host computer 150 executes part of the algorism of FIG. 4, and one of the exposure apparatuses 100ᵢ including the exposure apparatus 100₁ executes the rest thereof; especially the exposure apparatus 100₁ executes the steps 264, 266, 268, 270. However, for example, an exposure apparatus having the same grid correction functions as the exposure apparatus 100₁ may execute the entire algorism of FIG. 4 or part of the steps that the host computer 150 would execute.

In addition, in the first embodiment coordinates of all shot areas of at least one wafer of a plurality of wafers, from the first through (n−1)'th wafers, may be detected, and the at least one wafer may not include the first wafer, n being larger than or equal to three. Moreover, on the (n−1)'th wafer, coordinates of all shot areas may not be detected. Especially, if it can be predicted to some extent that nonlinear distortions on the wafer have almost the same trend, the coordinate of, for example, every other shot area may be detected. In addition, although in the EGA method the coordinates of alignment marks of alignment shot areas are used, for example, based on position deviation amounts relative to a mark on the reticle R or index mark of the alignment system AS, which are detected while moving the wafer to bring each alignment shot area to its coordinate on design, the position deviation, relative to a respective coordinate on design, of each shot area or a correction amount of the step pitch between adjacent shot areas may be calculated through a statistic computation. This also applies to a weighted EGA method and a multipoint-in-a-shot EGA described later.

That is, in the EGA method, such as the weighted EGA, multipoint-in-a-shot EGA and blocked EGA, any position information regarding alignment shot areas that is suitable for a statistical computation can be used as well as the coordinates of alignment shot areas.

<<A Second Embodiment>>

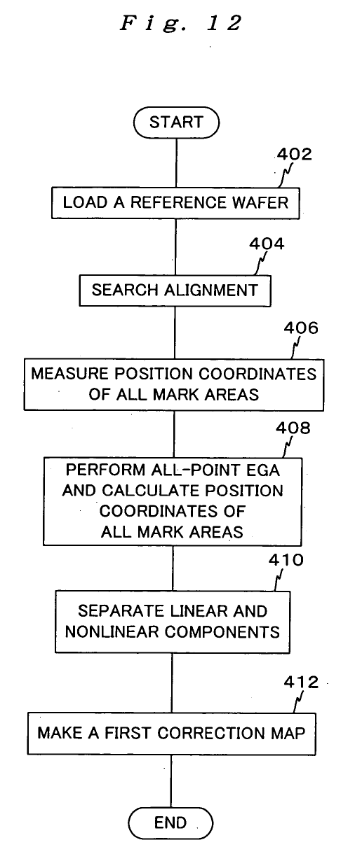

Next, a second embodiment of the present invention will be described with reference to FIGS. 12 to 15.

The arrangement of a lithography system of the second embodiment is the same as that of the first embodiment, and the second embodiment is different in that the first correction map is made by using a reference wafer on which reference marks are formed apart from each other by a distance smaller than the shot area size and that the process in the subroutine 270 of FIG. 4 is different from that of the first embodiment. The differences and others will be described in the below.

First, the flow of an operation of making the first correction map beforehand will be explained with reference to a flow chart in FIG. 12 schematically showing a control algorism of the CPU in the main control system 20 in the exposure apparatus 100₁.

As a premise it is assumed that as in the first embodiment, a reference wafer on which reference marks are formed apart from each other by a predetermined pitch smaller than the shot area size, e.g. 1 mm pitch, and are on respective rectangular areas or on some positions corresponding thereto has been prepared, the reference wafer being referred to as a “reference wafer W_{F}1” for the sake of convenience. Note that the respective rectangular areas corresponding to the reference marks are referred to as mark areas, hereinafter.

Note that the exposure apparatus used for preparation of the reference wafer may be a reference exposure apparatus (the most reliable scanning-stepper used in the same device manufacturing line) as in the first embodiment or a stationary exposure apparatus such as a stepper as long as it is highly reliable.

First, in a step 402 the wafer loader (not shown) loads the reference wafer W_{F}1 onto the wafer holder.

In a step 404, search alignment is performed on the reference wafer W_{F}1 on the wafer holder in the same way as in the step 204.

In a step 406, position coordinates, in the stage coordinate system, of all mark areas on the reference wafer W_{F}1 are measured in the same way as in the step 206, the mark area being, e.g., almost 1 mm squared.

In a step 408, by performing EGA computation of the equation (2) based on the position coordinates of all mark areas measured in the step 406 and position coordinates on design thereof, six parameters a through f in the above equation (1) are calculated, the six parameters corresponding respectively to rotation θ, scaling Sx and Sy in the X and Y directions, orthogonal degree Ort and offsets Ox and Oy in the X and Y directions, which all are related to the arrangement of each mark area. Then based on the calculation results and the position-coordinates on design of the mark areas, position-coordinates (arrangement coordinates) of all mark areas are calculated and the calculation results, i.e. position-coordinates of all mark areas on the reference wafer are stored in a predetermined area of the RAM.

A step 410 separates a linear component and nonlinear component of position deviation amount for each mark area on the reference wafer. Specifically, a difference between a position-coordinate of each mark area calculated in the step 408 and a respective position-coordinate in terms of design is calculated and taken as a respective linear component. And a difference between a position-coordinate measured in the step 406 for the mark area and a respective position-coordinate in terms of design is calculated, and the difference minus the linear component is taken as a respective nonlinear component.

In a step 412, the first correction map including the position deviation amount of each mark area calculated in the step 410 and the nonlinear component of the position deviation amount of each mark area as correction information for correcting arrangement deviation of the mark area on the reference wafer W_{F}1 is made and stored in a RAM or a storage unit. Then the process in this routine ends.

After that the reference wafer is unloaded from the wafer holder.

Next, the process of a subroutine 270 in the second embodiment will be described.

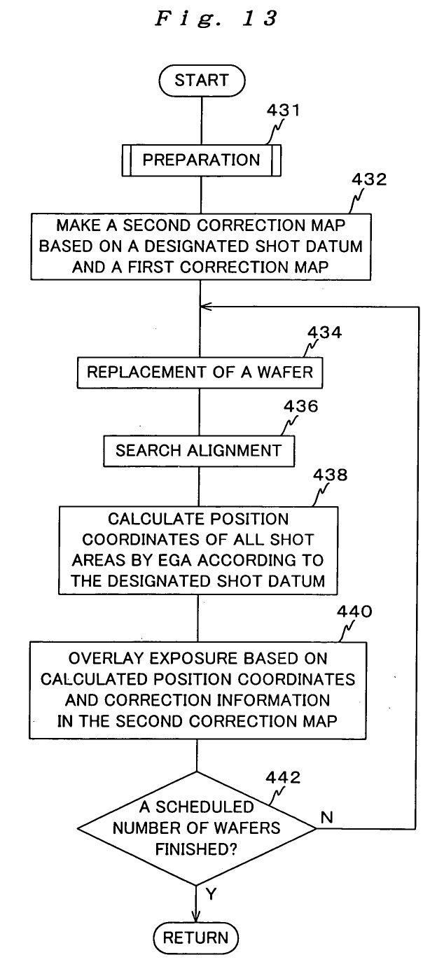

FIG. 13 shows a control algorism of the CPU in the main control system 20 for performing exposure of the second or later layer on a plurality of wafers (e.g. 25 wafers) in the same lot, which algorism is executed in the subroutine 270. The process of the subroutine 270 will be explained with reference to a flow chart in FIG. 13 and other figures as necessary.

As a premise it is assumed that all wafers in the lot have been through the same process with the same conditions.

First, after a subroutine 431 has performed a predetermined preparation in the same way as in the subroutine 201, the sequence advances to a step 432. Based on a shot map datum contained in the process program file, selected upon the above preparation based on the setting instruction information for an exposure condition given by the host computer 150, and the first correction map stored in the RAM, a second correction map is made and stored in the RAM, the second correction map being composed of pieces of correction information for correcting nonlinear components of position deviation amounts of shot areas defined by the shot map datum. That is, in the step 432, based on respective position deviation amounts of the mark areas contained in the first correction map and a predetermined evaluation function, the nonlinear distortion of the reference wafer W_{F}1 is evaluated, and on the evaluation result the complement function is determined that is a function expressing the nonlinear components of position deviation amounts (arrangement deviations). By using the determined complement function and pieces of correction information of mark areas each corresponding to the centers of the shot areas (in this case, each of the mark areas having the center of a respective shot area therein) the complement computation is performed, and the second correction map composed of pieces of correction information for correcting nonlinear components of position deviation amounts of the shot areas is made.

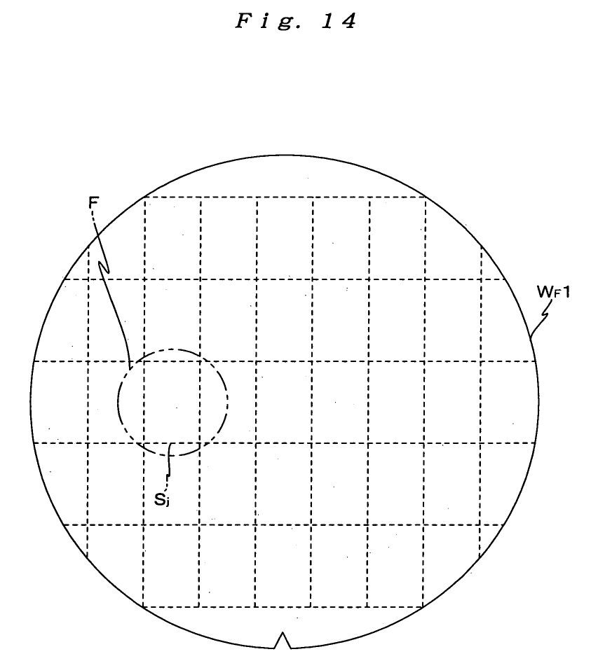

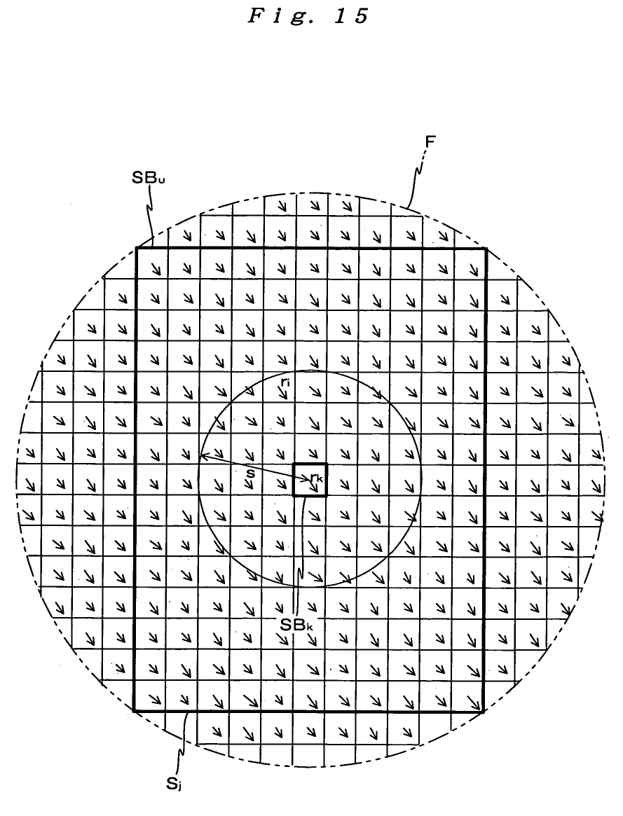

Next, the process of the step 432 will be explained in detail. FIG. 14 shows a plan view of the reference wafer W_{F}1, and FIG. 15 shows an enlarged view of the inside of the circle F in FIG. 14. On the reference wafer W_{F}1, a plurality of rectangular mark areas SBᵤ (the total number=N) are arranged with a predetermined pitch (e.g. 1 mm pitch) and in a matrix shape, the pitch meaning the distance between adjacent centers thereof. In FIG. 14 a shot area designated by the shot map datum is represented by a rectangular area Sⱼ, and in FIG. 15 this area is surrounded by thick lines. In FIG. 15 vectors rₖ (k=1 to i through N) symbolized by arrows in mark areas each represent the position deviation amount (arrangement deviation) of a respective mark area. The k shows the number of a mark area. In addition, ‘s’ represents the radius of a circle of which the center coincides with the center of a shot area SBₖ that is now under consideration and ‘i’ represents a mark area number within the circle of radius s.

As seen in the above description, in the process of the step 432, the evaluation function W₁(s) can be used as an evaluation function. Moreover, the complement function δₓ(x, y), δ_{y}(x, y) can be used as a complement function. According to the evaluation function W₁(s) the regularity and degree of the nonlinear distortion of the wafer can be evaluated not depending on a rule of thumb because the value of W₁(s) varies depending on the value of s. By using the evaluation results the most suitable P, Q for expressing nonlinear components of position deviation amounts (arrangement deviations) and thus the complement function given by equations (10), (11) can be determined.

Then by using the complement function given by equations (10), (11), and the X-component Δₓ(x, y) and the Y-component Δ_{y}(x, y) of the nonlinear component of the position deviation amount (arrangement deviation) of each mark area having a coordinate (x, y), which components are stored as a piece of correction information in the first correction map, Fourier series coefficients A_{pq}, B_{pq}, C_{pq}, D_{pq}, and A_{pq}′, B_{pq}′, C_{pq}′, D_{pq}′ are determined and thus the complement function is specifically determined. And by using the center coordinates of shot areas on the wafer and the complement function with determined Fourier series coefficients A_{pq}, B_{pq}, C_{pq}, D_{pq}, and A_{pq}′, B_{pq}′, C_{pq}′, D_{pq}′, the X-component and the Y-component of the nonlinear component (a complement value, i.e. a correction value) of the arrangement deviation for each shot area on the wafer have been calculated, and based on the calculation results the second correction map is made and temporarily stored in a predetermined area of the internal memory. In addition, other data than the correction map, i.e. the complement function with determined Fourier series coefficients A_{pq}, B_{pq}, C_{pq}, D_{pq}, and A_{pq}′, B_{pq}′, C_{pq}′, D_{pq}′, are stored in the RAM.

Note that although upon evaluating the regularity and degree of nonlinear distortion on part of the wafer W, position deviation amount vectors of the mark areas are used as the first and second vectors, vectors each expressing a piece of correction information, i.e. the nonlinear component of the position deviation amount of a respective mark area may be used.

Referring back to FIG. 13, in a next step 434, the wafer loader (not shown) replaces the wafer already exposed on the wafer holder 25 with a wafer not yet exposed. Note that if there is not a wafer on the wafer holder, a wafer W not yet exposed is merely loaded onto the wafer holder 25.

A step 436 performs search alignment on the wafer loaded onto the wafer holder in the same manner as the above.

In the step 438, according to the shot map datum and shot datum such as information for selecting alignment shot areas, wafer alignment of the EGA method is performed in the same manner as the above, and position-coordinates of all shot areas on the wafer are calculated and stored in a predetermined area of the internal memory.

A step 440, based on the arrangement coordinates of all shot areas stored in the predetermined area of the internal memory and the correction value (correction information) of the nonlinear component of the position deviation amount of each shot area in the second correction map temporarily stored in the internal memory, calculates a corrected overlay position for each shot area, having the position deviation amount (linear and nonlinear components) corrected. And the following two operation are repeated to perform exposure of the step-and-scan type: based on the corrected overlay position and a base-line amount measured beforehand, each time a different shot area on the wafer W is moved to the acceleration-start position (scan-start position) by stepping; and a reticle pattern is transferred on the wafer while synchronously moving the reticle stage RST and wafer stage WST. By this, exposure process for the first wafer W of the lot ends.

In a step 442 it is checked if exposure for a scheduled number of wafers has been finished. If the answer is NO, the sequence returns to the step 434. After that, the above process is repeated.

If exposure for the scheduled number of wafers has been finished, and the answer in the step 442 is YES, the sequence returns from the subroutine in FIG. 13 to FIG. 4, and the whole process ends.

Meanwhile, in the step 432 of the subroutine 270, based on a shot map datum contained in the process program file, for an exposure condition, designated by the host computer 150 upon exposure instruction, and the first correction map stored in the RAM, the second correction map is made. Therefore, in the step 432 if the shot map datum is changed, the second correction map is updated based on the new shot map datum. Specifically, the main control system 20 reads out the complement function with determined Fourier series coefficients stored in the RAM, and after by using the complement function and the center coordinates of shot areas on the wafer according to the new shot map datum, the X-component and the Y-component of the nonlinear component (a complement value, i.e. a correction value) of the arrangement deviation of each shot area have been calculated, the second correction map is updated based on the calculation results, and temporarily stored in the predetermined area of the internal memory. After that, the same process of the steps 434 through 442 is repeated.

Needless to say, while the shot map datum does not change, the same process as the above is performed.

Note that although the step 410 in FIG. 12 has separated the linear component and nonlinear component of position deviation amount for each mark area by using a respective position-coordinate measured in the step 406, a respective position-coordinate in terms of design and position-coordinate calculated in the step 408, only the nonlinear component may be calculated without separating the linear and nonlinear components. In this case, the difference between the position-coordinate for the shot area measured in the step 406 and the respective position-coordinate calculated in the step 408 may be taken as the nonlinear component. Furthermore, if the rotation error of the wafer W is within a permissible range, search alignment in the step 436 in FIG. 13 may be omitted.

As described above, according to the second embodiment, a plurality of reference marks on the reference wafer are detected; pieces of position information of mark areas corresponding to the respective reference marks are measured, and based on the pieces of measured position information, pieces of position information for the mark areas, each having the linear component of the position deviation amount relative to a respective design value corrected, are calculated by the statistic computation (EGA computation). Then, made based on the pieces of measured position information and the pieces of calculated position information, is the first correction map including a piece of position information for correcting the nonlinear component of the position deviation, of each mark area, relative to a respective design value. In this case, because the making of the first correction map is performed before exposure, it does not affect the throughput of exposure.

Then when, before exposure, a shot map datum is designated as part of the exposure condition, the first correction map is converted to a second correction map, based on the shot map datum, the second correction map including pieces of correction information used to correct nonlinear components of position deviation amounts of the shot areas, each of the position deviation amounts being relative to a reference position (design value) of a respective shot area of the shot areas. Then, pieces of position information used to align each shot area on a wafer with respect to a predetermined point (projection position of a reticle pattern) are calculated through use of a statistic computation (EGA computation) based on the pieces of position information, in the stage coordinate system, of shot areas obtained by detecting a plurality of marks on the wafer and while moving the wafer based on the pieces of position information and the second correction map, exposure is performed on the shot areas. That is, the pieces of position information of the shot areas which have been obtained by the above statistic computation based on the pieces of position information, in the stage coordinate system, of shot areas (measured position information) so as to be used for alignment with respect to the predetermined point and have a linear component of a position deviation amount relative to a respective reference position corrected are corrected by using corresponding ones of the pieces of correction information contained in the second correction map, and then after based on the pieces of position information each of the shot areas on the wafer has been moved to the acceleration start position, exposure is performed. Accordingly, because each shot area is accurately moved to the predetermined point based on position information of the shot area having both linear and nonlinear components of the position deviation amount corrected and exposure is performed, highly accurate exposure having almost no overlay errors is possible.

Therefore, according to the second embodiment, exposure can be performed with preventing the drop of throughput as much as possible and keeping the accuracy of overlay. In addition, according to the second embodiment, because pieces of position information used to align each shot area on a wafer with respect to the predetermined point are corrected using pieces of correction information calculated based on measurement results of reference marks on the reference wafer, all exposure apparatuses in the same device manufacturing line can be adjusted by using the reference wafer as a reference so as to improve overlay accuracy thereof.

According to the second embodiment, when, before exposure, a shot map datum is designated as part of the exposure condition, the first correction map is converted, based on the shot map datum, to the second correction map including a piece of position information for correcting the nonlinear component of the position deviation, of each shot area, relative to a respective reference position (design value). Therefore, regardless of the contents of the shot map datum, overlay exposure between a plurality of exposure apparatuses can be accurately performed.

Moreover, in the second embodiment the conversion from the first correction map to the second correction map is done by performing the complement computation, for the reference position (center position) of each shot area, based on the pieces of correction information of the mark areas and a complement function optimized according to the results of evaluating the regularity and degree of nonlinear distortion on part of the reference wafer by using the evaluation function. Thus, a complement function for calculating nonlinear distortions (correction information) of all points on a wafer upon the conversion is determined. Accordingly, when the shot map datum and thus the shot area's size are changed, a piece of correction information of each new shot area can be calculated by using the complement function and coordinate of the new shot area. Therefore, it is easy to respond to the change of shot map data.

In the second embodiment, in the case where because imperfect shot areas among shot areas in the periphery of the wafer (edge shot areas) have no necessary mark, the first correction map does not include pieces of correction information of the imperfect shot areas, the pieces of correction information of the imperfect shot areas can be calculated.

That is because if shot areas designated by the shot map datum include imperfect shot areas, upon the conversion of the maps, pieces of correction information of the imperfect shot areas are also automatically calculated by using the reference position (center position) of each imperfect shot area and the complement function.

However, the way to convert the first correction map to the second correction map is not limited to this. By, for the reference position (center position) of each shot area, calculating a piece of correction information of the reference position based on pieces of correction information of mark areas adjacent thereto through use of the weighted average computation assuming a Gauss distribution, the conversion can be done. In this case the radius of the circle containing such adjacent mark areas for the weighted average computation may be determined by the above evaluation function. Or instead of the weighted average computation, the simple average for adjacent mark areas contained in a circle for the reference position (center position) of each shot area may be used, the radius of the circle being determined by the evaluation function. In the first embodiment, upon calculating pieces of correction information of such imperfect shot areas, a combination of the evaluation function and the weighted average computation or the simple average can be used.

In the above first and second embodiments, in the subroutine 268 correction values of linear components of position deviation amounts for the first wafer are calculated by the EGA computation using all shot areas as alignment shot areas. However, correction values of linear components of position deviation amounts for the first wafer may be calculated by the EGA computation using designated alignment shot areas like for the second or later wafer.

In addition, in the above first and second embodiments, coordinates of alignment marks of alignment shot areas are used to perform wafer alignment of the EGA method, the alignment shot areas being all or selected shot areas. By detecting position deviation amounts relative to a mark on the reticle R or index mark of the alignment system AS while moving the wafer to bring each alignment shot area to the coordinate on design and performing the statistic computation, the position deviation, relative to a respective coordinate on design, of each shot area may be calculated, or the correction amount of the step pitch between adjacent shot areas may be calculated.

Furthermore, although the above first and second embodiments describe cases of using the EGA method, the weighted EGA method or the multipoint-in-shot EGA method may be used instead of the EGA method. The multipoint-in-shot EGA method is disclosed, for example, in Japanese Patent Laid-Open No. 6-349705 and U.S. patent application Ser. No. 569,400 (application date: Dec. 8, 1995) corresponding thereto. In this method, by detecting a plurality of alignment marks in each alignment shot area, a plurality of (X, Y) coordinates are obtained, and a model function including as a parameter at least one of shot parameters (chip parameters) corresponding respectively to rotation errors, orthogonal degree and scaling of shot areas as well as wafer parameters corresponding respectively to expansion and rotation of wafers used in the EGA method is used to calculate position information, e.g. a coordinate value, of each shot area. The disclosure in the above U.S. patent application is incorporated herein by reference as long as the national laws in designated states or elected states, to which this international application is applied, permit.

The method will be described in more detail in the below. In the multipoint-in-shot EGA method, on each shot area on a wafer, a plurality of alignment marks (either a one-dimensional mark or two-dimensional mark) are formed at positions each having a relation, in terms of design, to the reference position of the shot area, and position information of such a predetermined number of alignment marks on the wafer is measured that the total number of measured X-position information items and Y-position information items is larger than the total number of wafer and shot parameters contained in the above model function. Moreover, the predetermined number of alignment marks are selected so as to obtain a plurality of information items in the same direction in each alignment shot area. Then by performing a statistic computation on the position information by using the above model function, and the least square method or the like, values of the parameters contained in the model function are calculated, and based on the parameter values and based on position information, on design, of the reference position of each shot area and relative-position information, on design, of alignment marks, position information of the shot area is calculated.

In this case, although coordinate values of the alignment marks can be used as position information, any information that is related to alignment marks and suitable for the statistic computation may be used.

Furthermore, in a case of applying this invention to the weighted EGA method, the weight parameter S of the equations (4) or (6) is determined by using the above evaluation function. Specifically, in the same manner as in the step 308 in FIG. 8, position-coordinates of all shot areas of a first wafer in a lot are measured, and by calculating the difference between the measured position-coordinate and the design value of each shot area, a position deviation, i.e. a position deviation amount vector, of the shot area is obtained. Next, based on the position deviation amount vector and the evaluation function W₁(s) given by, e.g., the equation (8), the nonlinear distortion of the wafer W is evaluated, and a value of radius s at which W₁(s) is larger than 0.8 is searched for, correlation between shot areas inside a circle having a radius of the value being considered strong. Then by substituting the s, or multiplied s by a constant, for B in the equation (7), the weight parameter S of the equations (4) or (6) and thus the weighted Wᵢₙ or Wᵢₙ′ can be determined not depending on a rule of thumb.

There are, for example, the following two sequences of wafer process for, e.g., a lot, which use the weighted EGA method where the weight parameter S and thus the weighted Wᵢₙ or Wᵢₙ′ are determined.

(A First Sequence)

After the process of the steps 308, 310 in FIG. 5 has been performed on the first wafer, the following process a. through d. is performed sequentially.

a. Position deviation amounts of all shot areas are calculated. b. The weight parameter S is determined based on the position deviation amounts and the evaluation function in the same manner as the above. c. Based on the weight parameter S, arrangement coordinates of all shot areas are calculated by the weighted EGA method. d. Made based on the difference between the arrangement coordinates (weighted EGA results) calculated in the c. and the arrangement coordinates (EGA results) calculated in the step 610, is a map (complement map for nonlinear components) of nonlinear components (correction values) of arrangement deviations of the shot areas.

Then upon the exposure of the first wafer, based on the complement map of nonlinear components and the arrangement coordinates calculated in the step 610, an overlay corrected position of each shot area is calculated, and while based on the overlay-corrected position and a base line amount measured beforehand, each shot area on the wafer W is moved to the acceleration-start position (scan-start position) by stepping to perform exposure of the step-and-scan method. For the second or later wafer, the step 320 is executed, and based on the results of the eight-point EGA and the complement map of nonlinear components, the overlay-corrected positions of the shot areas are calculated, and based on the overlay-corrected positions, exposure of the step-and-scan method is performed.

According to the first sequence, the effect equivalent to the first embodiment can be obtained.

(A Second Sequence)

For example, after the position coordinates of all shot areas have been measured in the same manner as in the step 308 of FIG. 5, position deviation amounts of all shot areas are calculated that each are the difference between the measured position and a respective arrangement coordinate on design. Next, a value of the weight parameter S is determined based on the position deviation amounts and the evaluation function in the same manner as the above. Then based on the value of the weight parameter S, the arrangement coordinates of all shot areas are calculated by the weighted EGA method. Then upon the exposure of the first wafer, based on the overlay-corrected positions, which are the arrangement coordinates of the shot areas calculated by the weighted EGA method, and a base-line amount measured beforehand, each shot area on the wafer W is moved to the scan-start position by stepping, exposure of the step-and-scan method is performed.

Upon alignment of the second or later wafer, the number and arrangement of sample shots are determined based on the weight parameter S determined upon alignment of the first wafer, and based on measured position coordinates of alignment marks on the selected sample shots, the arrangement coordinate of each shot area is calculated by the weighted EGA method. Needless to say, weighting according to the weight parameter S determined upon alignment of the first wafer in the lot is performed in the weighted EGA. Then using the calculated arrangement coordinates as the overlay-corrected positions, exposure of the step-and-scan method is performed on the second or later wafer.

That is, upon alignment of the weighted EGA method according to the prior art, a nonlinear distortion of, e.g., the first wafer is evaluated, and based on the evaluation results the weight parameter S is determined for the second or later wafer as well as the first wafer not depending on a rule of thumb. Because according to the second sequence the number and arrangement of sample shots in accord with the degree of the wafer's nonlinear distortion can be determined, and appropriate weighting is possible, highly accurate alignment exposure can be realized with a least number of sample shots in spite of using the weighted EGA method according to the prior art.

<<A Third Embodiment>>

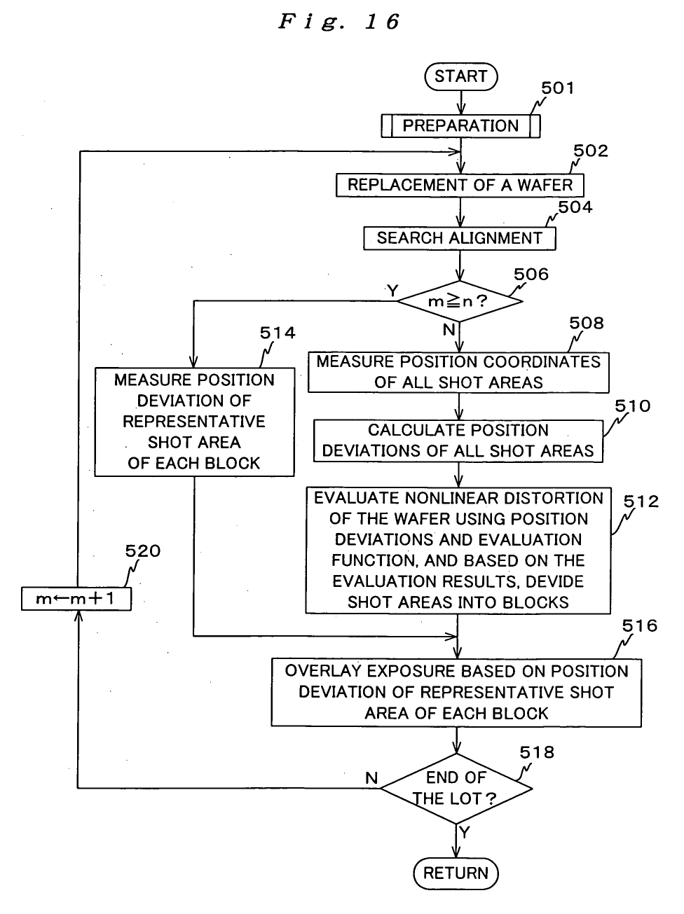

Next, a third embodiment of the present invention will be described with reference to FIG. 16. The arrangement of a lithography system of the third embodiment is the same as that of the first embodiment, and the third embodiment is different in that the subroutine 268 of FIG. 4 is different from that of the first embodiment. The difference and others will be described in the below.

FIG. 16 shows a control algorism of the CPU in the main control system 20 in the exposure apparatus 100₁, which algorism is for performing exposure for the second or later layer on a plurality of wafers (e.g. 25 wafers) in the same lot. The process of the subroutine 268 will be described with reference to the flow chart of FIG. 16 in the below.

As a premise it is assumed that all wafers in the lot have been through the same process with the same conditions and that a counter (not shown) indicating a wafer number (m) in the lot has been set to one. The wafer number will be explained later.

First, after in the subroutine 501 a predetermined preparation has been performed in the same way as in the subroutine 301, the sequence advances to a step 502. In the step 502 the wafer loader (not shown) replaces the wafer already exposed (from here on, referred to as ‘W′’) on the wafer holder 25 in FIG. 1 with a wafer W not yet exposed. If there is not the wafer W′, a wafer W not yet exposed is merely loaded onto the wafer holder 25.

A step 504 performs search alignment on the wafer W loaded onto the wafer holder 25 in the same manner as in the first embodiment.

A step 506, by checking if the value m of the counter is larger or equal to a predetermined number n, checks if the wafer W on the wafer holder 25 (wafer stage WST) is an n'th or later in the lot. The n is an arbitrary number between 2 and 25 inclusive, and from here on, for the sake of convenience it is assumed that the n is equal to two. Here, because the wafer W is the first wafer of the lot (m=1), the answer in the step 506 is NO, and the sequence advances to a step 508.

In a step 508, position-coordinates, in the stage coordinate system, of all shot areas on the wafer W are measured in the same way as in the step 308.

In the step 510, based on the measurement results in the step 508 position deviation amounts (relative to design values) of all shot areas on the wafer W are calculated.

In a step 512, based on the position deviation amounts of all shot areas calculated in the step 510 and the evaluation function, the nonlinear distortion of the wafer W is evaluated, and based on the evaluation results, shot areas on the wafer W are divided into a plurality of blocks. Specifically, while calculating the evaluation functions W₁(s) and W₂(s) (equations (8), (15)) based on the position deviation amounts of all shot areas calculated in the step 510, a value of radius s at which both the evaluation functions are in the range of. 0.9 to 1 is searched for, and in this way, the radius s of a circle, of shot areas in which the position deviation amounts (nonlinear distortions) have a similar trend to one another is determined. Then based on the value of radius s, the shot areas on the wafer W are divided into blocks, and information, of shot areas of each block, including a measurement value of a position deviation amount of a shot area representing the block, e.g. an arbitrary shot area in the block, is stored in a respective area in the internal memory.

In a next step 516, based on the position deviation amount of the representative shot area of each block, overlay alignment is performed. Specifically, first, based on the position coordinate (arrangement coordinate), on design, of each shot area and position deviation amount information of the representative shot area of a block to which the shot area belongs, the overlay-corrected position of the shot area is calculated. That is, by correcting the position coordinate, on design, of each shot area by using position deviation amount information of the representative shot area of the block to which the shot area belongs, the overlay-corrected position of the shot area is calculated. Then by repeating the step of moving each shot area on the wafer W to the scan-start position by stepping based on the overlay-corrected position and a base-line amount measured beforehand and the step of transferring a reticle pattern onto the wafer while synchronously moving the reticle stage RST and wafer stage WST, exposure of the step-and-scan method is performed. By this, exposure of the first wafer W in the lot ends.

In a next step 518, by checking whether or not the value m of the counter is larger than 24, it is checked whether or not exposure on all wafers of the lot has finished. Here, because the m is equal to 1, the answer is NO, and the sequence advances to a step 520. Then the counter is incremented by one (m←m+1), and the sequence returns to the step 502.

In the step 502 the wafer loader (not shown) replaces the first wafer already exposed on the wafer holder 25 with a second wafer W in the lot.

The step 504 performs search alignment on the wafer W (the second wafer in the lot) loaded onto the wafer holder 25 in the same manner as the above.

The step 506, by checking if the value m of the counter is larger or equal to a predetermined number n (=2), checks if the wafer W on the wafer holder 25 (wafer stage WST) is the second or later in the lot. Because, now, the wafer W is the second wafer of the lot (m=2), the answer in the step 506 is YES, and the sequence advances to a step 514.

In the step 514, a position deviation amount of the representative shot area of each block is measured. Specifically, a shot area in each block is selected as a representative shot area according to information regarding dividing into blocks stored in a predetermined area of the internal memory, and the position-coordinate, in the stage coordinate system, of a wafer mark in the representative shot area is detected. Then based on the detection result, the position deviation, relative to a respective design position-coordinate, of the wafer mark in the representative shot area is calculated, and replaced with the calculation result is a measured position deviation amount of the representative shot area contained in the predetermined area for the block of the internal memory. After, for all blocks, the same process has ended, the sequence advances to a step 516.

Note that in the step 514, a plurality of shot areas of which the number is smaller than the total shot area number in the block may be selected as representative shot areas. In the case where a plurality of shot areas are selected as representative shot areas, the position deviation amount, relative to a respective design position-coordinate, of a wafer mark in each representative shot area is calculated in the same way as the above, and the measured position deviation amount contained in the predetermined area for the block of the internal memory may be replaced with the average of the position deviation amounts of the representative shot areas.

In the step 516, in the same manner as the above, exposure process for the second wafer W in the lot is performed according to the step-and-scan method. After exposure for the second wafer W in the lot has finished, the sequence advances to the step 518, and it is checked if exposure for all wafers in the lot has finished. Now, the answer is NO, and the sequence returns to the step 502. After that, until exposure for all wafers in the lot has finished, the process from the step 502 through the step 518 is repeated.

If exposure for all wafers in the lot has finished, and the answer in the step 324 is YES, the sequence returns from the subroutine in FIG. 16 to FIG. 4, and the whole process ends.

According to the third embodiment, as in the first embodiment, the nonlinear distortion of a wafer can be evaluated by the evaluation function, not depending on a rule of thumb but on the clear ground. Then because, based on the evaluation results, shot areas on a wafer W are divided into blocks such that shot areas of each block have a similar trend in distortion, and for each block, wafer alignment similar to the die-by-die method (hereinafter, referred to as a “block-by-block” method for the sake of convenience) is performed, shot areas can be accurately aligned by almost accurately calculating linear and nonlinear components of arrangement deviations of the shot areas. Therefore, by moving each shot area on the wafer W to the acceleration start position (scan-start position) by stepping based on the arrangement deviations of the shot areas and transferring a reticle pattern onto the wafer, each shot area on the wafer W can accurately aligned with a reticle pattern.

Furthermore, in the subroutine 268 of the this embodiment, upon exposure of the second or later wafer in the lot, assuming the second and later wafers having the same trend in distortion as the first wafer and using the same block division, position deviation amounts of representative shot areas of the blocks are measured. Accordingly, the throughput can be improved compared with the case of measuring positions of all shot areas in all wafers of the lot because of reduced measurement points.

In addition, in the third embodiment upon exposure of the first wafer of the lot, based on the position coordinate (arrangement coordinate), on design, of each shot area and position deviation amount of the representative shot area of the block that the shot area belongs to, the overlay-corrected position of the shot area is calculated, and based on the calculation result, the shot area is positioned at a respective scan start position. However, based on the position deviation amount of each shot area calculated in the step 510, the shot area may be positioned at a respective scan start position without the above computation.

Moreover, in third embodiment if n is an integer larger than or equal to three, on first (n−1) wafers in the lot, the process from the steps 508 through 512 is repeated. At this time, in the step 512 for the second through (n−1) wafers, the division of shot areas into blocks may be determined based on, for example, the results of previous evaluations. Meanwhile, the division of shot areas into blocks determined for the first and/or another wafer may be used for the first (n−1) wafers without determining for each wafer.

In the first, second and third embodiments, to evaluate the nonlinear distortion of a wafer W, coordinates of alignment marks in each shot area are obtained by detecting the alignment marks. However, the nonlinear distortion may be evaluated by detecting position deviation amounts of the alignment marks relative to an index mark through use of the alignment system AS while positioning each shot area on the wafer at a coordinate that is a respective design coordinate plus the base-line amount. Moreover, the nonlinear distortion may be evaluated by using the reticle alignment system 22 instead of the alignment system AS and detecting a position deviation amount between an alignment mark of each shot area and a mark of the reticle R. That is, upon evaluation of the nonlinear distortion, it is not always necessary to obtain the coordinates of marks, and any position-information that are related to alignment marks or shot areas corresponding thereto can be used to evaluate the nonlinear distortion.

In addition, based on the value of radius s obtained by the evaluation using the above evaluation function, EGA measurement points for the EGA method, the weighted EGA method or the multipoint-in-shot EGA method can be appropriately determined.

Although each of the above embodiments describes a case where a FIA system (alignment sensor of an imaging method) of the off-axis method is used as a mark detection system, any mark detection system may be used such as a TTR (Through The Reticle) method, a TTL (Through The Lens) method, the off-axis method, or an other method, where, e.g., diffraction light or scattered light is detected, than the imaging method (a method by image processing). Furthermore, for example, an alignment system may be used where a coherent beam is made incident onto an alignment mark on a wafer almost vertically, and where by making the same order diffracted light beams from the mark to interfere with each other the mark is detected, the order being such as ±the first, ±the second, or ±the n'th order. In this case, for each order, the diffracted light may be detected to use the detection result of at least one of the orders, or by making coherent light beams having different wavelengths incident on the alignment mark and making each order diffraction light of each coherent light beam interfere, the alignment mark may be detected.

Furthermore, the present invention can be applied to an exposure apparatus of the step-and-repeat method, proximity method or another method such as an X-ray exposure apparatus as well as an exposure apparatus of the step-and-scan method.

Incidentally, as the exposure illumination light (energy beam) of an exposure apparatus, ultraviolet light, X-ray (including EUV light) or charged-particle beam such as electron beam or ion beam may be used, and this invention can be applied to an exposure apparatus for producing DNA chips, masks or reticles.

<<A Device Manufacturing Method>>

Next, the manufacture of devices by using the above exposure apparatus and method will be described.

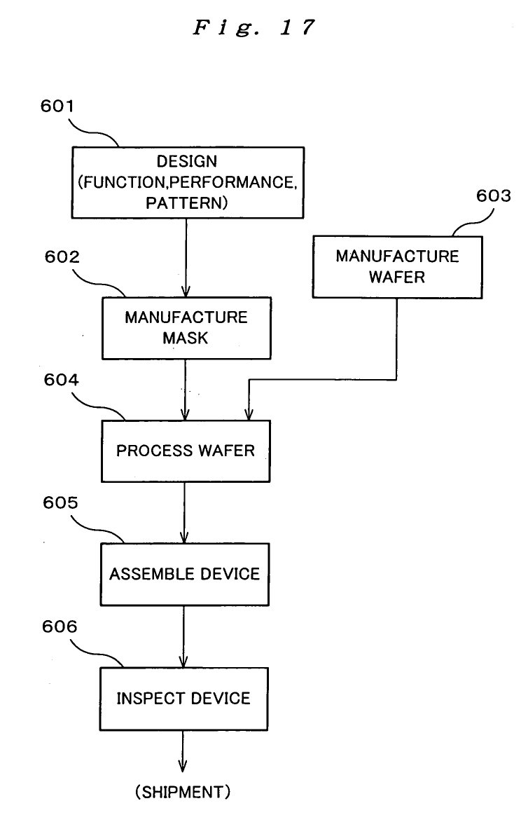

FIG. 17 is a flow chart for the manufacture of devices (semiconductor chips such as IC or LSI, liquid crystal panels, CCD's, thin magnetic heads, micro machines, or the like) in this embodiment. As shown in FIG. 17, in step 601 (design step), function/performance design for the devices (e.g., circuit design for semiconductor devices) is performed and pattern design is performed to implement the function. In step 602 (mask manufacturing step), masks on which a different sub-pattern of the designed circuit is formed are produced. In step 603 (wafer manufacturing step), wafers are manufactured by using silicon material or the like.

In step 604 (wafer processing step), actual circuits and the like are formed on the wafers by lithography or the like using the masks and the wafers prepared in steps 601 through 603, as will be described later. In step 605 (device assembly step), the devices are assembled from the wafers processed in step 604. Step 605 includes processes such as dicing, bonding, and packaging (chip encapsulation).

Finally, in step 606 (inspection step), a test on the operation of each of the devices, durability test, and the like are performed. After these steps, the process ends and the devices are shipped out.

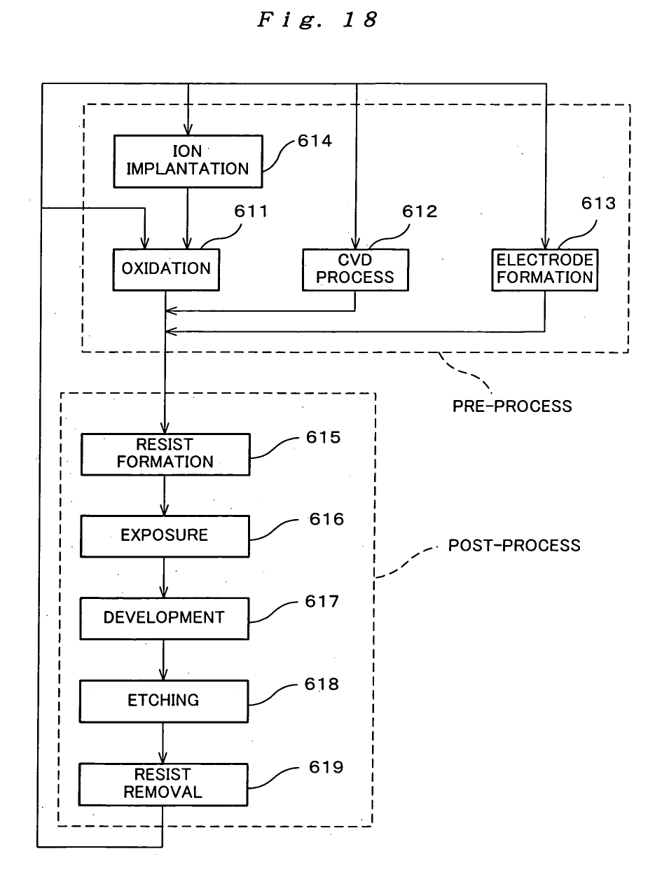

FIG. 18 is a flow chart showing a detailed example of step 604 described above in manufacturing semiconductor devices. Referring to FIG. 18, in step 611 (oxidation step), the surface of a wafer is oxidized. In step 612 (CVD step), an insulating film is formed on the wafer surface. In step 613 (electrode formation step), electrodes are formed on the wafer by vapor deposition. In step 614 (ion implantation step), ions are implanted into the wafer. Steps 611 through 614 described above constitute a pre-process for each step in the wafer process and are selectively executed in accordance with the processing required in each step.

When the above pre-process is completed in each step in the wafer process, a post-process is executed as follows. In this post-process, first of all, in step 615 (resist formation step), the wafer is coated with a photosensitive material (resist). In step 616, the above exposure apparatus transfers a sub-pattern of the circuit on a mask onto the wafer according to the above method. In step 617 (development step), the exposed wafer is developed. In step 618 (etching step), an exposing member on portions other than portions on which the resist is left is removed by etching. In step 619 (resist removing step), the unnecessary resist after the etching is removed.

By repeatedly performing these pre-process and post-process, a multiple-layer circuit pattern is formed on each shot-area of the wafer.

According to the device manufacturing method of this embodiment described above, upon exposure of wafers of each lot in the exposure step (step 616), the lithography system and the exposure method according to any of the above embodiment are used, and therefore it is possible to perform highly accurate exposure with improved accuracy of alignment between a reticle pattern and shot areas on a wafer and with minimizing the drop of the throughput. As a result, it is possible to transfer a finer circuit pattern onto a wafer with desirable overlay accuracy between layers of the circuit pattern and with minimizing the drop of the throughput, and the productivity (including the yield) of highly integrated micro devices can be improved. Especially, when using vacuum ultraviolet light such as F₂ laser light as the light source, the productivity of micro devices of which the smallest line width is, e.g., about 0.1 um can be improved with help of improvement of imaging resolution of the projection optical system.

Although the embodiments and modified examples thereof according to the present invention are suitable embodiments, organizations engaging in development and/or production of lithography systems can easily think of additions, modifications and replacements to the above embodiments within the scope of this invention. Such additions, modifications and replacements will be included in the present invention, which is defined by the following claims.

What is claimed is:

1. An evaluation method that evaluates regularity and degree of a nonlinear distortion of a substrate, comprising:
obtaining, for a plurality of divided areas on a substrate, position deviation amounts relative to predetermined reference positions by detecting respective marks, which are provided corresponding to said plurality of divided areas; and
evaluating regularity and degree of a nonlinear distortion of said substrate by using an evaluation function that is used to obtain correlation, concerning at least direction, between a first vector representing said position deviation amount of a given divided area on said substrate and second vectors each of which represents said position deviation amount of a divided area of a plurality of divide areas around said given divided area.

2. An evaluation method according to claim 1, wherein said evaluation function is a function that is used to obtain correlation, concerning direction and size, between said first vector and said second vectors.

3. An evaluation method according to claim 1, wherein in addition, by using said evaluation function, a correction value of a piece of position information used to align each of said divided areas with respect to a predetermined point is determined.

4. An evaluation method according to claim 1, wherein said evaluation function is a second function that represents an average of first N functions each of which is used to obtain correlation, concerning at least direction, between said first vector obtained by selecting a respective divided area of N divided areas on said substrate and said second vectors each of which represents said position deviation amount of a divided area of a plurality of divide areas around said respective divided area of said N divided areas, N being a natural number.

5. A position detection method that detects pieces of position information to be used to align each of a plurality of divided areas on a substrate with respect to a predetermined point, said method comprising:
calculating said piece of position information through use of a statistic computation using measured position information obtained by detecting said plurality of marks on said substrate; and
determining, for said piece of position information, at least one of a correction value and a correction parameter that determines said correction value, by using a function that is used to obtain correlation, concerning at least direction, between a first vector representing a position deviation amount of a given divided area on said substrate and second vectors each of which represents a position deviation amount of a divided area of a plurality of divide areas around said given divided area, said position deviation amount of said first vector being relative to a predetermined reference position, said position deviation amounts of said second vectors being relative to respective predetermined reference positions.

6. A position detection method according to claim 5, wherein, through said statistic computation, said pieces of position information having a linear component of a position deviation amount thereof corrected are calculated for said plurality of divided areas, and wherein at least one of said correction value and said correction parameter is determined by using said function so that a nonlinear component of said position deviation amount is corrected.

7. A position detection method according to claim 5, wherein said measured position information is in accord with position deviations of said divided areas relative to said predetermined point specified in design-position information, and wherein by performing a statistic computation using said measured position information obtained from measuring at least three specific divided areas of said plurality of divided areas on said substrate, parameters of a conversion equation that calculates said pieces of position information are obtained.

8. A position detection method according to claim 7, wherein parameters of said conversion equation are calculated with said measured position information being weighted with an amount for each of said specific divided areas, and wherein said weighting amount is determined by using said function.

9. A position detection method according to claim 5, wherein said measured position information contains coordinates of said marks in a stationary coordinate system defining movement position of said substrate, and wherein said pieces of position information are coordinates of said divided areas in said stationary coordinate system.

10. A position detection method according to claim 5, wherein said correction values of said pieces of position information are determined based on a complement function optimized using said function.

11. An exposure method that forms a predetermined pattern on each of a plurality of divided areas on a plurality of substrates by sequentially performing exposure of said plurality of divided areas on said plurality of substrates, said exposure method comprising:
detecting a piece of position information of each divided area on an n'th substrate of said plurality of substrates by using a position detection method according to claim 5, said n being larger than or equal to two; and
performing, after having moved each of said divided areas to an exposure reference position based on said detection results, exposure on said divided area.

12. A device manufacturing method including a lithography process, wherein in said lithography process, exposure is performed by using an exposure method according to claim 11.

13. A position detection method that detects a piece of position information to be used to align each of a plurality of divided areas on a substrate with respect to a predetermined point, wherein, for a second or later (n'th) substrate of said plurality of substrates, so as to detect a piece of position information of each of said plurality of divided areas of a plurality of substrates, are used a linear component of a piece of position information of said divided area obtained by performing a statistic computation using measured position information in accord with position deviations of at least three specific divided areas relative to said predetermined point specified in design-position information, and a nonlinear component of a piece of position information of said divided area on at least one of substrates earlier than said n'th substrate, said measured position information being measured by detecting a plurality of marks on said n'th substrate.

14. A position detection method according to claim 13, wherein said nonlinear component of a piece of position information of each of said divided areas is calculated based on a single complement function optimized based on indices of regularity and degree of a nonlinear distortion, of at least one of substrates earlier than said n'th substrate, that are obtained by, through use of a predetermined evaluation function, evaluating pieces of measured position information of said divided areas on said substrate, and based on a nonlinear component of a piece of position information of said divided area on at least one of substrates earlier than said n'th substrate.

15. A position detection method according to claim 14, wherein said complement function is a function expanded by the Fourier series, and wherein based on results of said evaluation a highest order of said Fourier series expansion is optimized.

16. A position detection method according to claim 13, wherein said nonlinear component of said piece of position information of each of said divided areas is calculated based on a difference between a piece of position information of said divided area, which is calculated by weighting measured position information, which is obtained by detecting a plurality of marks on said at least one of substrates earlier than said n'th substrate, and performing a statistic computation using said weighted information, and a piece of position information of said divided area calculated by performing a statistic computation using measured position information, which is obtained by detecting a plurality of marks on said at least one of substrates earlier than said n'th substrate.

17. An exposure method that forms a predetermined pattern on each of a plurality of divided areas on a plurality of substrates by sequentially performing exposure of said plurality of divided areas on said plurality of substrates, said exposure method comprising:
detecting a piece of position information of each divided area on an n'th substrate of said plurality of substrates by using a position detection method according to claim 13, said n being larger than or equal to two; and
performing, after having moved each of said divided areas to an exposure reference position based on said detection results, exposure on said divided area.

18. A device manufacturing method including a lithography process, wherein in said lithography process, exposure is performed by using an exposure method according to claim 17.

19. A position detection method that detects a piece of position information to be used to align each of a plurality of divided areas on a substrate with respect to a predetermined point, said method comprising:
grouping, for a second or later (n'th) substrate of a plurality of substrates, a plurality of divided areas on said substrate into blocks beforehand based on indices representing regularity and degree of a nonlinear distortion of at least one of substrates earlier than said n'th substrate so as to detect a piece of position information of each of said plurality of divided areas of said plurality of substrates, said indices being obtained by evaluating, through use of a predetermined evaluation function, measured position information in accord with position deviations, relative to said predetermined point, of said divided areas on said at least one of substrates earlier than said n'th substrate; and
determining said pieces of position information of all divided areas belonging to each of said blocks by using measured position information in accord with position deviations, relative to said predetermined point, of a second number of divided areas, said second number being smaller than a first number, which represents a total number of divided areas belonging to each of said blocks.

20. An exposure method that forms a predetermined pattern on each of a plurality of divided areas on a plurality of substrates by sequentially performing exposure of said plurality of divided areas on said plurality of substrates, said exposure method comprising:
detecting a piece of position information of each divided area on an n'th substrate of said plurality of substrates by using a position detection method according to claim 19, said n being larger than or equal to two; and
performing, after having moved each of said divided areas to an exposure reference position based on said detection results, exposure on said divided area.

21. A device manufacturing method including a lithography process, wherein in said lithography process, exposure is performed by using an exposure method according to claim 20.

22. A position detection method that detects a piece of position information to be used to align each of a plurality of divided areas on a substrate with respect to a predetermined point, said method comprising:
determining a weight parameter for weighting, by using a function that is used to obtain correlation, concerning at least direction, between a first vector representing a position deviation amount of a given divided area on said substrate and second vectors each representing a position deviation amount of a divided area of a plurality of divide areas around said given divided area, said position deviation amount of said first vector being relative to a predetermined reference position, said position deviation amounts of said second vectors being relative to said predetermined reference position; and
weighting measured position information, obtained by detecting a plurality of marks on said substrate, by using said weight parameter and calculating said piece of position information by a statistic computation using said weighted, measured position information.

23. An exposure method that forms a predetermined pattern on each of a plurality of divided areas on a plurality of substrates by sequentially performing exposure of said plurality of divided areas on said plurality of substrates, said exposure method comprising:
detecting a piece of position information of each divided area on an n'th substrate of said plurality of substrates by using a position detection method according to claim 22, said n being larger than or equal to two; and
performing, after having moved each of said divided areas to an exposure reference position based on said detection results, exposure on said divided area.

24. A device manufacturing method including a lithography process, wherein in said lithography process, exposure is performed by using an exposure method according to claim 23.

25. An exposure method that forms a predetermined pattern on each of a plurality of divided areas on a substrate by sequentially performing exposure of said plurality of divided areas on said substrate, said exposure method comprising:
making, for each of at least two conditions concerning said substrate, beforehand at least a correction map based on measurement results of a plurality of marks on a specific substrate, said correction map being composed of pieces of correction information used to correct nonlinear components of position deviation amounts, relative to respective reference positions, of a plurality of divided areas on said substrate;
selecting a correction map corresponding to a designated condition before exposure; and
calculating pieces of position information used to align each divided area with respect to a predetermined point, through use of a statistic computation, based on measured position information obtained by detecting a plurality of marks provided corresponding to each of a plurality of specific divided areas on said substrate and performing, after having moved said substrate based on said pieces of position information and said selected correction map, exposure on said divided areas.

26. An exposure method according to claim 25,
wherein said at least two conditions include at least two process conditions through which substrates have been,
wherein upon said map making, said correction map is made for each of a plurality of specific substrates that have been through different processes, and
wherein upon said selection, a correction map is selected that corresponds to a substrate subject to exposure.

27. An exposure method according to claim 25,
wherein said at least two conditions include at least two conditions concerning selection of said plurality of specific divided areas of which said marks are detected to obtain said measured position information,
wherein upon said map making, position deviation amounts relative to respective reference positions of a plurality of divided areas on said specific substrate are obtained by detecting marks provided corresponding to each of said plurality of divided areas on said specific substrate, wherein pieces of position information of said divided areas are calculated through use of a statistic computation using measured position information obtained by detecting marks corresponding to a plurality of specific divided areas that are corresponding to said condition and are on said specific substrate, for each of said conditions concerning selection of said specific divided areas, and wherein a correction map is made based on said pieces of position information and said position deviation amounts of said divided areas, said correction map being composed of pieces of correction information used to correct nonlinear components of position deviation amounts, relative to respective reference positions, of said divided areas; and
wherein upon said selection, a correction map is selected that corresponds to designated selection information of specific divided areas.

28. An exposure method according to claim 25,
wherein said specific substrate is a reference substrate.

29. An exposure method according to claim 25,
wherein upon said exposure, if divided areas on said substrate subject to exposure include an imperfect area which is in periphery of said substrate and of which a piece of correction information is not contained in said correction map, a piece of correction information of said imperfect area is calculated by a weighted-average computation based on a Gauss distribution and using pieces of correction information, contained in said correction map, of a plurality of divided areas adjacent to said imperfect area.

30. A device manufacturing method including a lithography process, wherein in said lithography process, exposure is performed by using an exposure method according to claim 25.

31. An exposure method that forms a predetermined pattern on each of a plurality of divided areas on a substrate by sequentially performing exposure of said plurality of divided areas on said substrate, said exposure method comprising:
measuring pieces of position information of mark areas each corresponding to a respective mark by detecting a plurality of marks on a reference substrate;
obtaining, by a statistic computation using said pieces of measured position information, pieces of calculated position information of said mark areas, each having a linear component of position deviation amount thereof, relative to a design value of a respective mark area, corrected;
making a first correction map including pieces of correction information used to correct nonlinear components of position deviation amounts of said mark areas, based on said pieces of measured position information and said pieces of calculated position information, each of said position deviation amounts being relative to a design value of a respective mark area;
converting, before exposure, said first correction map to a second correction map, based on information concerning a designated arrangement of divided areas, said second correction map including pieces of correction information used to correct nonlinear components of position deviation amounts of said divided areas, each of said position deviation amounts being relative to a reference position of a respective divided area of said divided areas; and
calculating pieces of position information, used to align each divided area with respect to a predetermined point, through use of a statistic computation based on measured position information obtained by detecting a plurality of marks on said substrate and performing, while moving said substrate based on said pieces of position information and said second correction map, exposure on said divided areas.

32. An exposure method according to claim 31,
wherein in said map conversion, a piece of correction information of a reference position on each of said divided areas is calculated by a weighted-average computation assuming a Gauss distribution, based on pieces of correction information of a plurality of mark areas adjacent to said reference position.

33. A position detection method according to claim 31, wherein said map conversion is realized by, for a reference position on each of said divided areas, performing a complement computation based on pieces of correction information of said mark areas and a single complement function optimized based on results of evaluating, through use of a predetermined evaluation function, regularity and degree of a nonlinear distortion of a region of a substrate.

34. A device manufacturing method including a lithography process, wherein in said lithography process, exposure is performed by using an exposure method according to claim 31.

35. An exposure method that forms a predetermined pattern on each of a plurality of divided areas on a plurality of substrates by using a plurality of exposure apparatuses including at least one exposure apparatus capable of correcting distortion of projected image and sequentially performing exposure of said divided areas on said substrates, said exposure method comprising:
an analysis step of analyzing overlay error information, measured beforehand, of at least one specific substrate that has been through the same process as said substrates;
a first judgment step of judging, based on said analysis results, whether or not errors between divided areas on said specific substrate are predominant, said errors between divided areas being caused by position deviation amounts having different translation components from each other;
a second judgment step of, when in said first judgment step it has been judged that said errors between divided areas are predominant, judging whether or not said errors between divided areas have a nonlinear component;
a first exposure step of, when in said second judgment step it has been judged that said errors between divided areas have no nonlinear component, with using an arbitrary exposure apparatus, calculating pieces of position information used to align each divided area with respect to a predetermined point., by a statistic computation using measured position information obtained by detecting marks corresponding to each of a plurality of specific divided areas on each of said plurality of substrates and sequentially performing exposure on said plurality of divided areas of each of said plurality of substrates so as to form said pattern on each divided area, while moving said substrate based on said pieces of position information;
a second exposure step of, when in said second judgment step it has been judged that said errors between divided areas have a nonlinear component, with using an exposure apparatus that can perform exposure on substrates correcting said errors between divided areas, sequentially performing exposure on said plurality of divided areas of each of said plurality of substrates so as to form said pattern on each divided area; and
a third exposure step of, when in said first judgment step it has been judged that said errors between divided areas are not predominant, selecting an exposure apparatus capable of correcting distortion of said projected image and, with using said selected exposure apparatus, sequentially performing exposure on said plurality of divided areas of each of said plurality of substrates so as to form said pattern on each divided area.

36. An exposure method according to claim 35, further comprising:
a selection step of, when in said second judgment step it has been judged that said errors between divided areas have a nonlinear component, selecting and instructing an exposure apparatus that can perform exposure on substrates correcting said errors between divided areas to perform exposure;
a third judgment step of judging how large differences of overlay errors between a plurality of lots are, said lots including a lot to which a substrate subject to exposure belongs; and
wherein in said second exposure step, when upon sequentially performing exposure on said plurality of divided areas of each of said plurality of substrates so as to form said pattern on each divided area, in said third judgment step it has been judged that differences of overlay errors between lots are large, said exposure apparatus, for each of a predetermined number of first and following substrates of said lot, calculates pieces of position information used to align each divided area with respect to a predetermined point, by a statistic computation using measured position information obtained by detecting a plurality of marks on said substrate, calculates nonlinear components of position deviation amounts, relative to respective predetermined reference positions, of said divided areas by using said measured position information and a predetermined function, and moves said substrate based on said pieces of position information calculated and said nonlinear components, and for each of the other substrates, calculates pieces of position information used to align each divided area with respect to a predetermined point, by a statistic computation using measured position information obtained by detecting a plurality of marks on said substrate, and moves said substrate based on said pieces of position information calculated and said nonlinear components calculated, and
wherein when in said third judgment step it has been judged that differences of overlay errors between lots are not large, said exposure apparatus, for each substrate of said lot, calculates pieces of position information used to align each divided area with respect to a predetermined point, by a statistic computation using measured position information obtained by detecting a plurality of marks on said substrate, and moves said substrate based on said pieces of position information calculated and a correction map that is made beforehand and composed of pieces of correction information used to correct nonlinear components of position deviation amounts, relative to respective reference positions, of a plurality of divided areas on a substrate.

37. A device manufacturing method including a lithography process, wherein in said lithography process, exposure is performed by using an exposure method according to claim 35.

38. An exposure apparatus that forms a predetermined pattern on each divided area on a plurality of substrates by performing exposure on said substrates, said exposure apparatus comprising:
a judgment unit of judging how large differences of overlay errors between a plurality of lots are, said lots including a lot to which a substrate subject to exposure belongs;
a first controller that, when said judgment unit judges that differences of overlay errors between lots are large, upon exposure for each of a predetermined number of first and following substrates of said lot, calculates pieces of position information used to align each divided area with respect to a predetermined point, by a statistic computation using measured position information obtained by detecting a plurality of marks on said substrate, calculates nonlinear components of position deviation amounts, relative to respective predetermined reference positions, of said divided areas by using said measured position information and a predetermined function, and moves said substrate based on said pieces of position information calculated and said nonlinear components, and upon exposure for each of the other substrates in said lot, calculates pieces of position information used to align each divided area with respect to a predetermined point, by a statistic computation using measured position information obtained by detecting a plurality of marks on said substrate, and moves said substrate based on said pieces of position information calculated and said nonlinear components calculated; and
a second controller that, when said judgment unit judges that differences of overlay errors between lots are not large, upon exposure for each substrate of said lot, calculates pieces of position information used to align each divided area with respect to a predetermined point, by a statistic computation using measured position information obtained by detecting a plurality of marks on said substrate, and moves said substrate based on said pieces of position information calculated and a correction map that is made beforehand and composed of pieces of correction information used to correct nonlinear components of position deviation amounts, relative to respective reference positions, of a plurality of divided areas on a substrate.

39. An exposure method that forms a predetermined pattern on each of a plurality of divided areas on a substrate by performing exposure on said divided area, said exposure method comprising:
selecting a first alignment mode, when, based on overlay error information of an exposure apparatus used in exposure of said substrate, errors between divided areas on said substrate are predominant, and a second alignment mode different from said first alignment mode, when errors between divided areas on said substrate are not predominant; and
determining respective pieces of position information of said divided areas based on pieces of position information obtained by detecting a plurality of marks on said substrate using said selected alignment mode.
